(19) United States
(12) Patent Application Publication
(10) Pub. No.: US 2026/0292165 A1
(43) Pub. Date: Sep. 24, 2026

(54) VIDEO CODING METHOD

(71) Applicant: Tencent Technology (Shenzhen) Company Limited, Shenzhen (CN)

(72) Inventors: Renjie CHANG, Shenzhen (CN); Yingbin WANG, Shenzhen (CN); Liqiang WANG, Shenzhen (CN); Xiaozhong XU, Shenzhen (CN)

(73) Assignee: Tencent Technology (Shenzhen) Company Limited, Shenzhen (CN)

(21) Appl. No.: 19/680,929

(22) Filed: May 18, 2026

Related U.S. Application Data
(63) Continuation of application No. PCT/CN2024/109317, filed on Aug. 1, 2024.

(30) Foreign Application Priority Data
Dec. 9, 2023 (CN) 202311694332.X

(51) Int. Cl. H04N 19/117; H04N 19/159; H04N 19/186; H04N 19/80

(52) U.S. Cl. CPC H04N 19/117; H04N 19/159; H04N 19/186; H04N 19/80

(57) ABSTRACT

In a video decoding method, coding information of a to-be-decoded region is obtained from a bitstream, the coding information indicating at least one of a prediction mode, an interpolation direction, a coding component, or an interpolation target. In the method, a target interpolation filter corresponding to the to-be-decoded region is determined from a plurality of candidate interpolation filters based on the coding information, the plurality of candidate interpolation filters having different filter taps. In the method, a predicted value of the to-be-decoded region is determined through application of the target interpolation filter on a reference region.

### RELATED APPLICATIONS

The present application is a continuation of International Application No. PCT/CN2024/109317, filed on Aug. 1, 2024, which claims priority to Chinese Patent Application No. 202311694332.X, filed on Dec. 9, 2023, and entitled “VIDEO ENCODING METHOD AND APPARATUS, VIDEO DECODING METHOD AND APPARATUS, DEVICE, AND STORAGE MEDIUM.” The entire disclosures of the prior applications are hereby incorporated by reference.

### FIELD OF THE TECHNOLOGY

This disclosure relates to the field of video encoding and decoding technologies, including a video encoding method and apparatus, a video decoding method and apparatus, a device, and a storage medium.

### BACKGROUND OF THE DISCLOSURE

Digital video technologies may be incorporated into a plurality of video apparatuses, such as digital televisions, smartphones, computers, e-readers, or video players. With the development of video technologies, a volume of data included in video data has become increasingly large. To facilitate transmission of the video data, a video apparatus performs a video compression technology, to enable more efficient transmission or storage of video data.

Because temporal redundancy exists in a video, such temporal redundancy between video frames may be used to code the video through inter prediction, thereby improving compression efficiency. During the inter prediction, in some cases, an interpolation filter may to be used to perform interpolation prediction on a reference picture. However, at present, when the interpolation filter is determined, a problem that a prediction effect is poor due to inaccurate selection of the interpolation filter exists.

### SUMMARY

This disclosure provides a video encoding method and apparatus, a video decoding method and apparatus, a device, and a storage medium, so as to improve selection accuracy of an interpolation filter, and further improving a prediction performance of a video.

According to a first aspect, this disclosure provides a video decoding method. In the method, coding information of a to-be-decoded region is obtained from a bitstream, the coding information indicating at least one of a prediction mode, an interpolation direction, a coding component, or an interpolation target. In the method, a target interpolation filter corresponding to the to-be-decoded region is determined, by processing circuitry, from a plurality of candidate interpolation filters based on the coding information, the plurality of candidate interpolation filters having different filter taps. In the method, a predicted value of the to-be-decoded region is determined, by the processing circuitry, through application of the target interpolation filter on a reference region.

According to a second aspect, this disclosure provides a video encoding method. In the method, coding information of a to-be-encoded region is obtained, and a reference region corresponding to the to-be-encoded region is obtained, the coding information indicating at least one of a prediction mode, an interpolation direction, a coding component, or an interpolation target. In the method, a target interpolation filter corresponding to the to-be-encoded region is determined, by processing circuitry, from a plurality of candidate interpolation filters based on the coding information, the plurality of candidate interpolation filters having different filter taps. In the method, interpolation filtering is performed, by the processing circuitry, on the reference region based on the target interpolation filter, to determine a predicted value of the to-be-encoded region.

According to a third aspect, this disclosure provides a video decoding apparatus that includes processing circuitry configured to obtain, from a bitstream, coding information of a to-be-decoded region, the coding information indicating at least one of a prediction mode, an interpolation direction, a coding component, or an interpolation target. The processing circuitry is configured to determine a target interpolation filter corresponding to the to-be-decoded region from a plurality of candidate interpolation filters based on the coding information, the plurality of candidate interpolation filters having different filter taps. The processing circuitry is configured to determine a predicted value of the to-be-decoded region through application of the target interpolation filter on a reference region.

According to a fourth aspect, this disclosure provides a video encoding apparatus that includes processing circuitry configured to obtain coding information of a to-be-encoded region, and a reference region corresponding to the to-be-encoded region, the coding information indicating at least one of a prediction mode, an interpolation direction, a coding component, or an interpolation target. The processing circuitry is configured to determine a target interpolation filter corresponding to the to-be-encoded region from a plurality of candidate interpolation filters based on the coding information, the plurality of candidate interpolation filters having different filter taps. The processing circuitry is configured to perform interpolation filtering on the reference region based on the target interpolation filter, to determine a predicted value of the to-be-encoded region.

According to a fifth aspect, this disclosure provides a non-transitory computer-readable storage medium storing instructions, which when executed by a processor, cause the processor to perform a video decoding method. In the method, coding information of a to-be-decoded region is obtained from a bitstream, the coding information indicating at least one of a prediction mode, an interpolation direction, a coding component, or an interpolation target. In the method, a target interpolation filter corresponding to the to-be-decoded region is determined from a plurality of candidate interpolation filters based on the coding information, the plurality of candidate interpolation filters having different filter taps. In the method, a predicted value of the to-be-decoded region is determined through application of the target interpolation filter on a reference region.

According to a sixth aspect, this disclosure provides a non-transitory computer-readable storage medium storing instructions, which when executed by a processor, cause the processor to perform a video encoding method. In the method, coding information of a to-be-encoded region is obtained, and a reference region corresponding to the to-be-encoded region is obtained, the coding information indicating at least one of a prediction mode, an interpolation direction, a coding component, or an interpolation target. In the method, a target interpolation filter corresponding to the to-be-encoded region is determined from a plurality of candidate interpolation filters based on the coding information, the plurality of candidate interpolation filters having different filter taps. In the method, interpolation filtering is performed on the reference region based on the target interpolation filter, to determine a predicted value of the to-be-encoded region.

According to a seventh aspect, this disclosure provides a video decoding method, applied to a decoder or performed by a processor, and including: decoding a bitstream, to obtain coding information of a to-be-decoded region, the coding information including at least one of a prediction mode, an interpolation direction, a coding component, or an interpolation target; determining a target interpolation filter corresponding to the to-be-decoded region based on the coding information; and determining a reference region of the to-be-decoded region, and performing interpolation on the reference region based on the target interpolation filter, to determine a predicted value of the to-be-decoded region.

According to an eighth aspect, this disclosure provides a video encoding method, applied to an encoder or performed by a processor, and including: obtaining coding information of a to-be-encoded region, and a reference region corresponding to the to-be-encoded region, the coding information including at least one of a prediction mode, an interpolation direction, an coding component, or an interpolation target; determining a target interpolation filter corresponding to the to-be-encoded region based on the coding information; and performing interpolation filtering on the reference region based on the target interpolation filter, to determine a predicted value of the to-be-encoded region.

According to a ninth aspect, this disclosure provides a video decoding apparatus, applied to a decoder, and including: a decoding unit, configured to decode a bitstream, to obtain coding information of a to-be-decoded region, the coding information including at least one of a prediction mode, an interpolation direction, a coding component, or an interpolation target; a determining unit, configured to determine a target interpolation filter corresponding to the to-be-decoded region based on the coding information; and an interpolation unit, configured to determine a reference region of the to-be-decoded region, and perform interpolation on the reference region based on the target interpolation filter, to determine a predicted value of the to-be-decoded region.

According to a tenth aspect, this disclosure provides a video encoding apparatus, applied to an encoder, and including: an obtaining unit, configured to obtain coding information of a to-be-encoded region, and a reference region corresponding to the to-be-encoded region, the coding information including at least one of a prediction mode, an interpolation direction, an coding component, or an interpolation target; a determining unit, configured to determine a target interpolation filter corresponding to the to-be-encoded region based on the coding information; and an interpolation unit, configured to perform interpolation filtering on the reference region based on the target interpolation filter, to determine a predicted value of the to-be-encoded region.

According to an eleventh aspect, this disclosure provides a video decoder, including processing circuitry (e.g., a processor) and a memory. The memory (e.g., including a non-transitory computer-readable storage medium) is configured to store a computer program, and the processor is configured to invoke and run the computer program stored in the memory, to perform the foregoing method in the first aspect or various implementations thereof.

According to a twelfth aspect, this disclosure provides a video encoder, including processing circuitry (e.g., a processor) and a memory. The memory (e.g., including a non-transitory computer-readable storage medium) is configured to store a computer program, and the processor is configured to invoke and run the computer program stored in the memory, to perform the foregoing method in the second aspect or various implementations thereof.

According to a thirteenth aspect, this disclosure provides a video encoding and decoding system, including a video encoder and a video decoder. The video decoder is configured to perform the method in the foregoing first aspect or various implementations thereof, and the video encoder is configured to perform the foregoing method in any one of the first aspect to the second aspect or various implementations thereof.

According to a fourteenth aspect, this disclosure provides a chip, configured to implement the foregoing method in any one of the first aspect and the second aspect or various implementations thereof. In at least one aspect, the chip includes processing circuitry (e.g., a processor), configured to invoke a computer program from a memory (e.g., including a non-transitory computer-readable storage medium) and run the computer program, so that a device installed with the chip performs the foregoing method in any one of the first aspect to the second aspect or various implementations thereof.

According to a fifteenth aspect, this disclosure provides a non-transitory computer-readable storage medium, configured to store a computer program, the computer program causing a computer to perform the foregoing method in any one of the first aspect and the second aspect or various implementations thereof.

According to a sixteenth aspect, this disclosure provides a computer program product, including computer program instructions, the computer program instructions causing a computer to perform the foregoing method in any one of the first aspect and the second aspect or various implementations thereof.

According to an seventeenth aspect, this disclosure provides a computer program, the computer program, when run on a computer, causing the computer to perform the foregoing method in any one of the first aspect and the second aspect or various implementations thereof.

Based on the foregoing technical solutions, in this disclosure, a bitstream is decoded to obtain coding information of a to-be-decoded region, the coding information including at least one of a prediction mode, an interpolation direction, a coding component, or an interpolation target. A target interpolation filter corresponding to the to-be-decoded region is determined based on the coding information. A reference region of the to-be-decoded region is determined, and interpolation is performed on the reference region based on the target interpolation filter, to determine a predicted value of the to-be-decoded region. In other words, in one or more embodiments of this disclosure, a decoder side adaptively selects the target interpolation filter from interpolation filters each having a different quantity of taps based on coding information of a to-be-encoded region and coding information of a to-be-decoded region, for example, the prediction mode, the interpolation direction, the coding component, and the interpolation target, thereby improving accuracy of selection of the target interpolation filter. In this way, when the interpolation is performed on the reference region of the to-be-encoded region and the reference region of the to-be-decoded region based on the accurately selected target interpolation filter, to determine the predicted value of the to-be-encoded region and the predicted value of the to-be-decoded region, prediction performance of the to-be-encoded region and the to-be-decoded region may be improved, thereby improving performance of video encoding and decoding.

### BRIEF DESCRIPTION OF THE DRAWINGS

FIG. 1 is a schematic block diagram of a video encoding and decoding system according to an embodiment of this disclosure;

FIG. 2 is a schematic block diagram of a video encoder according to an embodiment of this disclosure;

FIG. 3 is a schematic block diagram of a video decoder according to an embodiment of this disclosure;

FIG. 4A is a schematic diagram of inter prediction;

FIG. 4B is a schematic diagram of pixel interpolation;

FIG. 5 is a schematic flowchart of a video decoding method according to an embodiment of this disclosure;

FIG. 6 is a schematic flowchart of a video encoding method according to an embodiment of this disclosure;

FIG. 7 is a schematic diagram of determining a plurality of candidate interpolation filters;

FIG. 8 is a schematic diagram of determining a target interpolation filter based on a rate-distortion cost;

FIG. 9 is a schematic block diagram of a video decoding apparatus according to an embodiment of this disclosure;

FIG. 10 is a schematic block diagram of a video encoding apparatus according to an embodiment of this disclosure; and

FIG. 11 is a schematic block diagram of an electronic device according to an embodiment of this disclosure.

### DETAILED DESCRIPTION

Technical solutions in this disclosure are described below with reference to accompanying drawings in one or more embodiments of this disclosure. The described embodiments are merely some rather than all of the embodiments of this disclosure. All other embodiments obtained by a person of ordinary skill in the art based on the embodiments of this disclosure shall fall within the scope of this disclosure.

The terms such as “first” and “second” in the specification and claims of this disclosure and in the accompanying drawings are configured for distinguishing similar objects and not necessarily configured for describing any particular order or sequence. Data used in this way is exchangeable in a proper case, so that the embodiments of this disclosure described herein can be implemented in another order other than those shown or described herein. In one or more embodiments of the present disclosure, “B corresponds to A” indicates that B is associated with A. In an implementation, B may be determined according to A. However, determining A according to B does not mean that B is determined based on only A. Instead, B may be determined based on A and/or other information. Moreover, terms “include” and “have” and any variations are intended to cover non-exclusive inclusion. For example, a process, a method, a system, a product, or a device that includes a list of operations or units is not necessarily limited to those expressly listed operations or units, and may include other operations or units not expressly listed or inherent to such the process, the method, the product, or the device. In the description of this disclosure, unless otherwise stated, “a plurality of” means two or more.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

This disclosure may be applied to the field of picture encoding and decoding, the field of video encoding and decoding, the field of hardware video encoding and decoding, the field of specific circuit video encoding and decoding, the field of real-time video encoding and decoding, and the like. For example, one or more solutions of this disclosure may be incorporated into an audio video coding standard (AVS), such as an H.264/audio video coding (AVC) standard, an H.265/high efficiency video coding (HEVC) standard, and an H.266/versatile video coding (VVC) standard. Alternatively, the solutions of this disclosure may be incorporated into other exclusive or industry standards for operation. The standards include ITU-TH.261, ISO/IECMPEG-1 Visual, ITU-TH.262 or ISO/IECMPEG-2Visual, ITU-TH.263, ISO/IECMPEG-4Visual, ITU-TH.264 (also referred to as ISO/IECMPEG-4AVC), and scalable video coding (SVC) and multiview video coding (MVC) extensions. The technology of this disclosure is not limited to any particular encoding and decoding standard or technology.

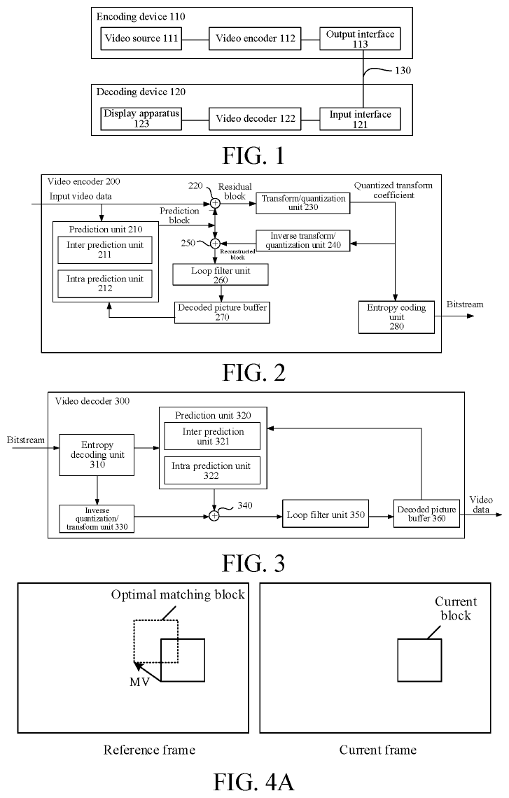

For ease of understanding, a video encoding and decoding system in an embodiment of this disclosure is first described with reference to FIG. 1.

FIG. 1 is a schematic block diagram of a video encoding and decoding system according to an embodiment of this disclosure. FIG. 1 is merely an example. The video encoding and decoding system of this embodiment of this disclosure includes but is not limited to that shown in FIG. 1. As shown in FIG. 1, the video encoding and decoding system 100 includes an encoding device 110 and a decoding device 120. The encoding device is configured to encode (which may be understood as compression) video data to generate a bitstream, and transmit the bitstream to the decoding device. The decoding device decodes the bitstream generated by the encoding device through encoding, to obtain decoded video data.

The encoding device 110 in this disclosure may be understood as a device having a video encoding function, and the decoding device 120 may be understood as a device having a video decoding function. To be specific, in this disclosure, the encoding device 110 and the decoding device 120 include a wider range of apparatuses, for example, a smartphone, a desktop computer, a mobile computing apparatus, a notebook (for example, laptop) computer, a tablet computer, a set-top box, a television, a camera, a display apparatus, a digital media player, a video game console, and an on-board computer.

In some embodiments, the encoding device 110 may transmit encoded video data (for example, a bitstream) to the decoding device 120 through a channel 130. The channel 130 may include one or more media and/or apparatuses that can transmit the encoded video data from the encoding device 110 to the decoding device 120.

In an example, the channel 130 includes one or more communication media that enable the encoding device 110 to transmit the encoded video data directly to the decoding device 120 in real time. In this example, the encoding device 110 may modulate the encoded video data based on a communication standard, and transmit the modulated video data to the decoding device 120. The communication media include a wireless communication medium, for example, a radio-frequency spectrum. In some embodiments, the communication media may further include a wired communication medium, for example, one or more physical transmission lines.

In another embodiment, the channel 130 includes a storage medium. The storage medium may store video data encoded by the encoding device 110. The storage medium includes various local access data storage media, for example, an optical disk, a DVD, and a flash memory. In one or more embodiments, the decoding device 120 may obtain the encoded video data from the storage medium.

In another embodiment, the channel 130 may include a storage server. The storage server may store the video data encoded by the encoding device 110. In this example, the decoding device 120 may download the stored encoded video data from the storage server. In some embodiments, the storage server may store the encoded video data and may transmit the encoded video data to the decoding device 120, for example, a web server (for example, for a website) or a file transfer protocol (FTP) server.

In some embodiments, the encoding device 110 includes a video encoder 112 and an output interface 113. The output interface 113 may include a modulator/demodulator (a modem) and/or a transmitter.

In some embodiments, in addition to the video encoder 112 and the output interface 113, the encoding device 110 may further include a video source 111.

The video source 111 may include at least one of a video capture apparatus (for example, a video camera), a video file, a video input interface, or a computer graphics system. The video input interface is configured to receive video data from a video content provider. The computer graphics system is configured to generate video data.

The video encoder 112 encodes video data from the video source 111, to generate a bitstream. The video data may include one or more pictures or a sequence of pictures. The bitstream includes coding information of the picture or the sequence of pictures in a form of a bitstream. The coding information may include encoded picture data and associated data. The associated data may include a sequence parameter set (SPS), a picture parameter set (PPS), and another syntactic structure. The SPS may include parameters applied to one or more sequences. The PPS may include parameters applied to one or more pictures. The syntactic structure refers to a collection of zero or more syntax elements arranged in a specified order in the bitstream.

The video encoder 112 directly transmits the encoded video data to the decoding device 120 through the output interface 113. The encoded video data may further be stored on a storage medium or a storage server for subsequent reading by the decoding device 120.

In some embodiments, the decoding device 120 includes an input interface 121 and a video decoder 122.

In some embodiments, in addition to the input interface 121 and the video decoder 122, the decoding device 120 may further include a display apparatus 123.

The input interface 121 includes a receiver and/or a modem. The input interface 121 may receive the encoded video data through the channel 130.

The video decoder 122 is configured to decode the encoded video data, to obtain decoded video data, and transmit the decoded video data to the display apparatus 123.

The display apparatus 123 displays the decoded video data. The display apparatus 123 may be integrated with the decoding device 120 or external to the decoding device 120. The display apparatus 123 may include a plurality of display apparatuses, for example, a liquid crystal display (LCD), a plasma display, an organic light-emitting diode (OLED) display, or another type of display apparatus.

In addition, FIG. 1 is merely an example. The technical solution of the embodiments of this disclosure is not limited to FIG. 1. For example, the technology of this disclosure may further be applied to one-sided video encoding or one-sided video decoding.

A video encoding framework involved in one or more embodiments of this disclosure is described below.

FIG. 2 is a schematic block diagram of a video encoder according to an embodiment of this disclosure. A video encoder 200 may be configured to perform lossy compression on a picture, or may be configured to perform lossless compression on the picture. The lossless compression may be visually lossless compression, or may be mathematically lossless compression.

The video encoder 200 may be applied to picture data in a luminance-chrominance (YCbCr, YUV) format. For example, a YUV ratio may be 4:2:0, 4:2:2, or 4:4:4, Y representing luminance (Luma), Cb (U) representing blue chrominance, Cr (V) representing red chrominance, and U and V representing chroma for describing color and saturation. For example, in a color format, 4:2:0 represents that every 4 pixels have 4 luminance components and 2 chrominance components (YYYYCbCr), 4:2:2 represents that every 4 pixels have 4 luminance components and 4 chrominance components (YYYYCbCrCbCr), and 4:4:4 represents full pixel display (YYYYCbCrCbCrCbCrCbCr).

For example, the video encoder 200 reads video data, and for each picture frame in the video data, a picture frame is divided into several coding tree units (CTUs). In some examples, the CTB may be referred to as a “tree block”, a “largest coding unit (LCU)”, or a “coding tree block (CTB)”. Each CTU may be associated with a pixel block of equal size in the picture. Each pixel may correspond to one luminance (or luma) sample and two chrominance (or chroma) samples. Therefore, each CTU may be associated with one luminance sampling block and two chrominance sampling blocks. A size of one CTU is for example 128×128, 64×64, or 32×32. One CTU may further be divided into several coding units (CUs) for encoding. Each of the CUs may be a rectangular block or a square block. The CU may further be divided into a prediction unit (PU) and a transform unit (TU), thereby separating encoding, prediction, and transformation for more flexible processing. In an example, the CTU is divided into the CUS through a quadtree, and the CU is divided into the TU and the PU through the quadtree.

The video encoder and a video decoder may support various PU sizes. Assuming that a size of a specific CU is 2N×2N, the video encoder and the video decoder may support the PU with a size of 2N×2N or N×N for intra prediction, and support a symmetric PU of 2N×2N, 2N×N, N×2N, N×N, or a similar size for inter prediction. The video encoder and the video decoder may further support asymmetric PUs of 2N×nU, 2N×nD, nL×2N, and nR×2N for inter prediction.

In some embodiments, as shown in FIG. 2, the video encoder 200 may include a prediction unit 210, a residual unit 220, a transform/quantization unit 230, an inverse transform/quantization unit 240, a reconstruction unit 250, a loop filter unit 260, a decoded picture buffer 270, and an entropy coding unit 280. The video encoder 200 may include more, fewer, or different functional components.

In some embodiments, in this disclosure, a current block may be referred to as a current CU, a current PU, or the like. A prediction block may also be referred to as a predicted picture block or a picture prediction block, and a reconstructed picture block may also be referred to as a reconstructed block or a picture reconstruction block.

In some embodiments, the prediction unit 210 includes an inter prediction unit 211 and an intra prediction unit 212. Since a strong correlation exists between adjacent pixels in a video frame, in video encoding and decoding technologies, spatial redundancy between the adjacent pixels is eliminated through an intra prediction method. Since a strong similarity exists between adjacent frames in a video, in the video encoding and decoding technologies, temporal redundancy between the adjacent frames is eliminated through an inter prediction method, thereby improving encoding efficiency.

The inter prediction unit 211 may be configured for inter prediction. The inter prediction may include motion estimation and motion compensation. Reference may be made to picture information of different frames. During the inter prediction, the motion information is used to find a reference block from a reference frame, and a prediction block is generated based on the reference block, to eliminate the temporal redundancy. The frame used during the inter prediction may be a P-frame and/or a B-frame. The P-frame refers to a forward prediction frame, and the B-frame refers to a bidirectional prediction frame. During the inter prediction, the motion information is used to find the reference block from the reference frame, and the prediction block is generated based on the reference block. The motion information includes a reference frame list where the reference frame is located, a reference frame index, and a motion vector. The motion vector may be an integer-pixel motion vector or a sub-pixel motion vector. If the motion vector is the sub-pixel motion vector, a sub-pixel block may be generated through interpolation filtering in the reference frame. The integer-pixel or sub-pixel block in the reference frame found based on the motion vector is referred to as a reference block herein. In some technologies, the reference block is directly used as the prediction block. In some technologies, the prediction block is generated through further processing based on the reference block. The generating the prediction block through further processing based on the reference block may also be understood as using the reference block as a prediction block and then performing processing based on the prediction block to generate a new prediction block.

The intra prediction unit 212 only refers to information of the same picture frame to predict pixel information in a current code picture block, to eliminate the spatial redundancy. The frame used for the intra prediction may be an I-frame.

The intra prediction has a plurality of prediction modes. An international digital video coding standard H series is used as an example. The H.264/AVC standard has 8 angle prediction modes and 1 non-angle prediction mode, and the H.265/HEVC extension to 33 angle prediction modes and 2 non-angle prediction modes. Intra prediction modes used in the HEVC include 35 prediction modes in total, including a planar mode, a DC mode, and 33 angle modes. The intra prediction modes used in the VVC include 67 prediction modes in total, including a planar mode, a DC mode, and 65 angle modes.

With an increase in the angle modes, the intra prediction is more accurate and better meets requirements for the development of high-definition and ultra-high-definition digital videos.

The residual unit 220 may generate a residual block of the CU based on a pixel block of the CU and a prediction block of the PU of the CU. For example, the residual unit 220 may generate the residual block of the CU, so that each sample in the residual block has a value equal to a difference between a sample in the pixel block of the CU and a corresponding sample in the prediction block of the PU of the CU.

The transform/quantization unit 230 may quantize a transform coefficient. The transform/quantization unit 230 may quantize a transform coefficient associated with the TU of the CU based on a quantization parameter (QP) value associated with the CU. The video encoder 200 may adjust, by adjusting the QP value associated with the CU, a degree of quantization applied to a transform coefficient associated with the CU.

The inverse transform/quantization unit 240 may apply inverse quantization and inverse transform to the quantized transform coefficient to reconstruct the residual block from the quantized transform coefficient.

The reconstruction unit 250 may add samples of the reconstructed residual block to corresponding samples of one or more prediction blocks generated by the prediction unit 210, to generate a reconstructed picture block associated with the TU. In this manner, a sampling block of each TU of the CU is reestablished, and the video encoder 200 may reconstruct a pixel block of the CU.

The loop filter unit 260 is configured to process pixels obtained after inverse transform and inverse quantization to compensate for distorted information, and provide a better reference for subsequent encoded pixels, for example, may perform a deblocking filtering operation to reduce a blocking effect of the pixel block associated with the CU.

In some embodiments, the loop filter unit 260 includes a deblocking filter unit and a sample adaptive offset/adaptive loop filtering (SAO/ALF) unit, where the deblocking filter unit is configured to remove the blocking effect, and the SAO/ALF unit is configured to remove a ringing effect.

The decoded picture buffer 270 may store a reconstructed pixel block. The inter prediction unit 211 may perform inter prediction on a PU of another picture through a reference picture including the reconstructed pixel block. In addition, the intra prediction unit 212 may perform intra prediction on another PU in the same picture as the CU by using the reconstructed pixel block in the decoded picture buffer 270.

The entropy coding unit 280 may receive the quantized transform coefficient from the transform/quantization unit 230. The entropy coding unit 280 may perform one or more entropy coding operations on the quantized transform coefficient to generate entropy-coded data.

FIG. 3 is a schematic block diagram of a video decoder according to an embodiment of this disclosure.

As shown in FIG. 3, the video decoder 300 includes an entropy decoding unit 310, a prediction unit 320, an inverse quantization/transform unit 330, a reconstruction unit 340, a loop filter unit 350, and a decoded picture buffer 360. The video decoder 300 may include more, fewer, or different functional components.

The video decoder 300 may receive a bitstream. The entropy decoding unit 310 may parse the bitstream to extract a syntax element from the bitstream. As a portion of parsing the bitstream, the entropy decoding unit 310 may parse an entropy-coded syntax element in the bitstream. The prediction unit 320, the inverse quantization/transform unit 330, the reconstruction unit 340, and the loop filter unit 350 may decode the video data based on the syntax element extracted from the bitstream, to generate decoded video data.

In some embodiments, the prediction unit 320 includes an intra prediction unit 322 and an inter prediction unit 321.

The intra prediction unit 322 may perform intra prediction to generate a prediction block of a PU. The intra prediction unit 322 may use an intra prediction mode to generate the prediction block of the PU based on a pixel block of a spatially adjacent PU. The intra prediction unit 322 may further determine the intra prediction mode of the PU based on one or more syntax elements parsed from the bitstream.

The inter prediction unit 321 may construct a first reference picture list (list 0) and a second reference picture list (list 1) based on the syntax element parsed from the bitstream. In addition, if the PU uses the inter prediction encoding, the entropy decoding unit 310 may parse motion information of the PU. The inter prediction unit 321 may determine one or more reference blocks of the PU based on the motion information of the PU. The inter prediction unit 321 may generate the prediction block of the PU based on one or more reference blocks of the PU.

The inverse quantization/transform unit 330 may perform inverse quantization (i.e., dequantization) on a transform coefficient associated with the TU. The inverse quantization/transform unit 330 may determine a degree of quantization through a QP value associated with the CU of the TU.

After the inverse quantization of the transform coefficient, the inverse quantization/transform unit 330 may apply one or more inverse transforms to inverse-quantized transform coefficients to generate a residual block associated with the TU.

The reconstruction unit 340 uses the residual block associated with the TU of the CU and the prediction block of the PU of the CU to reconstruct a pixel block of the CU. For example, the reconstruction unit 340 may add a sample of the residual block to a corresponding sample of the prediction block to reconstruct the pixel block of the CU, thereby obtaining a reconstructed picture block.

The loop filter unit 350 may perform a deblocking filtering operation to reduce a blocking effect of a pixel block associated with the CU.

The video decoder 300 may store a reconstructed picture of the CU in the decoded picture buffer 360. The video decoder 300 may use the reconstructed picture in the decoded picture buffer 360 as a reference picture for subsequent prediction, or transmit the reconstructed picture to a display apparatus for presentation.

A basic process of video encoding and decoding is as follows: at an encoder side, a picture frame is divided into blocks, and for a current block, the prediction unit 210 generates a prediction block of the current block through intra prediction or inter prediction. The residual unit 220 may calculate a residual block based on the prediction block and an original block of the current block, i.e., a difference between the prediction block and the original block of the current block. The residual block may also be referred to as residual information. The residual block may remove, by the transform/quantization unit 230 through transformation and quantization processes, information that is not sensitive to the human eye, thereby eliminating visual redundancy. In some embodiments, a residual block before the transformation and quantization by the transform/quantization unit 230 may be referred to as a time-domain residual block, and a time-domain residual block after the transformation and quantization by the transform/quantization unit 230 may be referred to as a frequency residual block or a frequency-domain residual block. The entropy coding unit 280 receives a quantized transform coefficient outputted by the transform/quantization unit 230, and may perform entropy coding on the quantized transform coefficient, to output a bitstream. For example, the entropy coding unit 280 may eliminate character redundancy based on a target context model and probability information of a binary bitstream.

At a decoder side, the entropy decoding unit 310 may parse the bitstream to obtain prediction information, a quantization coefficient matrix, and the like of the current block. The prediction unit 320 performs intra prediction or inter prediction on the current block based on the prediction information, to generate a prediction block of the current block. The inverse quantization/transform unit 330 performs inverse quantization and inverse transform on the quantization coefficient matrix by using the quantization coefficient matrix obtained from the bitstream, to obtain a residual block. The reconstruction unit 340 adds the prediction block and the residual block to obtain a reconstructed block. The reconstructed blocks form a reconstructed picture, and the loop filter unit 350 performs loop filtering on the reconstructed picture based on the picture or based on the blocks, to obtain a decoded picture. The encoder side may perform similar operations as the decoder side to obtain the decoded picture. The decoded picture may also be referred to as the reconstructed picture, and the reconstructed picture may be a subsequent frame serving as a reference frame for inter prediction.

Block division information determined by the encoder side, and mode information or parameter information such as prediction, transform, quantization, entropy coding, loop filtering, and the like may be carried in the bitstream. The decoder side determines the same mode information such as block division information, prediction, transformation, quantization, entropy coding, and loop filtering, or parameter information as the encoder side by parsing the bitstream and through analysis based on the information, thereby ensuring that the decoded picture obtained by the encoder side is the same as the decoded picture obtained by the decoder side.

The foregoing description is a basic process of a video codec in a block-based hybrid coding framework. With the development of technologies, some modules or operations of the framework or the process may be optimized. This disclosure is applicable to the basic process of the video codec in the block-based hybrid coding framework, but is not limited to the framework and the process.

In one or more embodiments of this disclosure, the current block may be a current CU, a current PU, or the like. Due to a requirement of parallel processing, a picture may be divided into slices and the like, and slices in the same picture may be processed in parallel. In other words, no data dependence exists between the slices. The term “frame” is a related expression, and a frame may generally be understood as a single picture. In this disclosure, the frame may also be replaced with a picture, a slice, or the like.

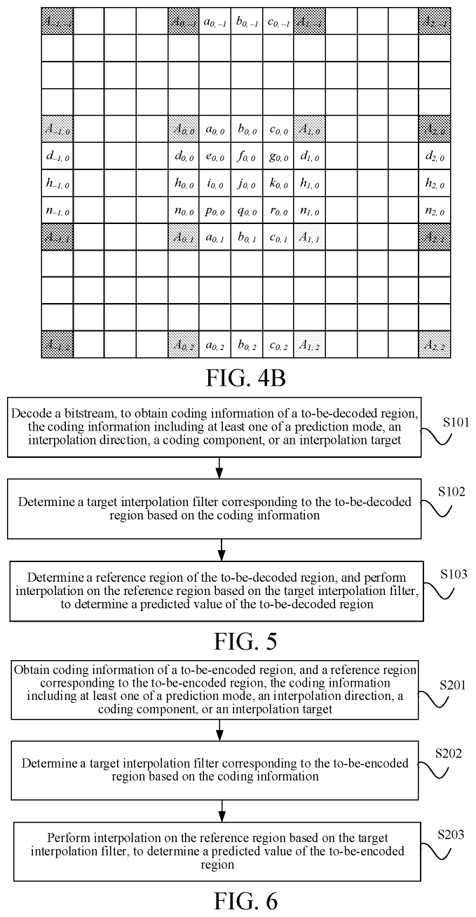

Inter prediction refers to a process in which a to-be-encoded block (for example, a current block) in a current picture is predicted to obtain a reference block from an adjacent encoded picture (for example, a reference picture). An objective is to remove temporal redundancy of a video signal. A schematic diagram of inter prediction is shown in FIG. 4A. According to a block matching criterion, an optimal matching block of the current block is found in the reference frame.

During the inter prediction, motion information is used for representing “motion”. The basic motion information includes information of the reference frame (or referred to as the reference picture) and information of a motion vector (MV). In related bidirectional prediction, 2 reference blocks are used to predict the current block. A forward reference block and a backward reference block may be used as the 2 reference blocks. It is subsequently permitted that the 2 reference blocks are both forward reference blocks, or the 2 reference blocks are both backward reference blocks. The “forward” means that the time corresponding to the reference frame is prior to that corresponding to the current frame, and the “backward” means that the time corresponding to the reference frame is subsequent to that corresponding to the current frame. Alternatively, the “forward” means that a position of the reference frame in the video is prior to that of the current frame, and the “backward” means that the position of the reference frame in the video is subsequent to that of the current frame. Alternatively, the “forward” means that a picture order count (POC) of the reference frame is less than a POC of the current frame, and the “backward” means that the POC of the reference frame is greater than the POC of the current frame. To enable use of bidirectional prediction, 2 reference blocks may be found, and then information of 2 sets of reference frames and the information of the motion vector may be used. Each set of reference frames may be understood as a piece of unidirectional motion information, and the 2 sets of reference frames are combined together to form a piece of bidirectional motion information. During specific implementation, the unidirectional motion information and the bidirectional motion information may use the same data structure, but the information of 2 sets of reference frames and the information of the motion vector in the bidirectional motion information are valid, and the information of one of the sets of reference frames and the information of the motion vector in the unidirectional motion information are invalid.

The VVC supports 2 reference frame lists, which are denoted as RPL0 and RPL1, where RPL is short for reference picture list. A P slice in the VVC may only use the RPL0, and a B slice may use the RPL0 and the RPL1. For a slice, each reference frame list includes several reference frames, and a codec finds a reference frame through a reference frame index. During the VVC, the reference frame index and the motion vector are used for representing the motion information. For example, for the foregoing bidirectional motion information, during the VVC, a reference frame index refIdxL0 corresponding to a reference frame list 0, a motion vector mvL0 corresponding to the reference frame list 0, a reference frame index refIdxL1 corresponding to a reference frame list 1, and a motion vector mvL0 corresponding to the reference frame list 1 are used. The reference frame index corresponding to the reference frame list 0 and the reference frame index corresponding to the reference frame list 1 herein may be understood as the information of the foregoing reference frames. During the VVC, two flag bits are respectively used for indicating whether motion information corresponding to the reference frame list 0 is used and whether motion information corresponding to the reference frame list 1 is used, which are respectively denoted as predFlagL0 and predFlagL1. predFlagL0 and predFlagL1 may also indicate whether the foregoing unidirectional motion information is “valid”. Therefore, although motion information such as a data structure is not explicitly mentioned in the VVC, the motion information is represented jointly by the reference frame index corresponding to each reference picture list, the motion vector, and a flag bit indicating whether the motion information is valid. In the normative text of VVC, the term “motion information” does not appear; instead, the motion vector is adopted. It may also be considered that the reference frame index and the flag indicating whether the corresponding motion information is used are appendages of the motion vector. In this specification, for ease of description, the term “motion information” is still used, but the term “motion vector” may also be configured for description.

It may be learned from the above that for the inter prediction, a pixel prediction value may be obtained from the reference frame through the motion vector. In practical scenarios, the motion of objects between adjacent pictures is not necessarily based on integer-pixel units. Therefore, enhancing the precision of motion estimation to a sub-pixel level and performing interpolation on reference pictures may improve prediction accuracy, so as to improve accuracy of motion compensation and further enhance encoding efficiency. As shown in FIG. 4B, pixel points where an uppercase letter A is located are integer-pixel points, such as A_{0, 0} and A_{1, 0}, and pixel points where lowercase letters such as a, b, and c are located are sub-pixel points. For example, a_{0, 0} represents a ¼-pixel point in an X-direction, and b_{0, 0} represents a ½-pixel point in the X-direction. For example, a common inter prediction mode in AVS3 supports five motion vector precisions, namely ¼, ½, 1, 2, and 4. When the MV precision is ¼ or ½, for example, an 8-tap interpolation filter may be used for interpolating obtain a luminance prediction value, and a 4-tap interpolation filter may be used for interpolating a chrominance prediction value.

In related bidirectional prediction, weighted averaging is performed on two reconstructed blocks, to obtain a predicted value of a current block, where the two reconstructed blocks are respectively from a forward reference frame and a backward reference frame. Further, to improve a prediction effect, a bi-directional optical flow (BIO) technology may be adopted to compensated for motion obtained after bidirectional prediction, to reduce a motion deviation and improve the encoding efficiency. In at least one aspect, the BIO in the AVS3 first calculates gradient values in an x-direction and a y-direction (the x-direction represents a horizontal direction, and the y-direction represents a vertical direction throughout the text), then obtains a calculation factor for each pixel based on a pixel value and the gradient values, derives a motion vector, and finally calculates a more accurate predicted value. In an example, when the gradient value in the x-direction is calculated, the BIO first uses an 8-tap gradient filter to perform gradient calculation, and then uses an 8-tap interpolation filter to perform interpolation. When the gradient value in the y-direction is calculated, the BIO first uses the 8-tap interpolation filter to perform interpolation, and then uses the 8-tap gradient filter to perform gradient calculation. In addition, the BIO technology is only applied to the luminance component.

It may be learned from the above that currently, when a predicted value or the gradient is determined through interpolation, a selected interpolation filter is appointed. For example, during interpolation prediction, an 8-tap interpolation filter is selected to interpolate a luminance prediction value, and a 4-tap interpolation filter is selected to interpolate a chrominance prediction value. When a gradient is calculated in the BIO, the 8-tap interpolation filter is selected. Currently, in the process of determining the interpolation filter, codec-related information is not taken into account, which results in inaccurate selection of the interpolation filter and thus leads to a poor video prediction effect.

To resolve the foregoing technical problem, in one or more embodiments of this disclosure, an interpolation filter is adaptively selected through coding information of a to-be-encoded region and coding information of a to-be-decoded region, for example, a prediction mode, an interpolation direction, a coding component, and an interpolation target, so that the selection of the interpolation filter is combined with the coding information and the coding information, thereby improving accuracy of selection of the interpolation filter. In this way, when the interpolation is performed on a reference region of the to-be-encoded region and a reference region of the to-be-decoded region based on the accurately selected target interpolation filter, to determine a predicted value of the to-be-encoded region and a predicted value of the to-be-decoded region, prediction effects of the to-be-encoded region and the to-be-decoded region may be improved, thereby improving performance of video encoding and decoding.

The technical solutions of the embodiments of this disclosure are described in detail below by using some embodiments. The following several embodiments may be combined with each other, and the same or similar concepts or processes may not be described repeatedly in some embodiments.

First, the decoder side is used as an example. A video decoding method provided in one or more embodiments of this disclosure is described.

FIG. 5 is a schematic flowchart of a video decoding method according to an embodiment of this disclosure. The embodiments of this disclosure are applied to the video decoder shown in FIG. 1 and FIG. 3 or executed by a processor. As shown in FIG. 5, the method in this disclosure includes the following operations.
S101: Decode a bitstream, to obtain coding information of a to-be-decoded region. For example, coding information of a to-be-decoded region is obtained from a bitstream, the coding information indicating at least one of a prediction mode, an interpolation direction, a coding component, or an interpolation target.

The coding information includes at least one of a prediction mode, an interpolation direction, a coding component, or an interpolation target.

A specific size and shape of the to-be-decoded region are not limited in this disclosure.

In some embodiments, the to-be-decoded region may be one or more to-be-decoded picture blocks in a to-be-decoded current frame, for example, may be one or more CTUs, one or more CUs, or one or more PUs. Certainly, the to-be-decoded region may further include an incomplete CTU, an incomplete CU, an incomplete PU, or the like. In an example, the to-be-decoded picture block may be referred to as a current block, a current to-be-decoded picture block, or the like.

In some embodiments, the to-be-decoded region may be a to-be-decoded current frame. In other words, the to-be-decoded region is a complete picture frame.

During video decoding, when decoding the to-be-decoded region, the decoder side decodes the bitstream to obtain a quantization coefficient of the to-be-decoded region, performs inverse quantization on the quantization coefficient to obtain a transform coefficient of the to-be-decoded region, and performs inverse transform on the transform coefficient to obtain a residual value of the to-be-decoded region. Next, a prediction mode of the to-be-decoded region is determined, a predicted value of the to-be-decoded region is determined based on the prediction mode, and a reconstructed value of the to-be-decoded region is obtained based on the predicted value and the residual value of the to-be-decoded region.

The embodiments of this disclosure mainly involve a prediction process of the to-be-decoded region.

In one or more embodiments of this disclosure, to improve prediction accuracy of the to-be-decoded region, an interpolation filter is used for performing interpolation on a reference region of the to-be-decoded region. However, currently, during selection of the interpolation filter, the coding information of a to-be-decoded region is not considered, resulting in inaccurate selection of the interpolation filter.

To resolve the foregoing technical problem, in one or more embodiments of this disclosure, the bitstream is decoded to obtain the coding information of the to-be-decoded region, and a target interpolation filter of the to-be-decoded region is determined based on the coding information, to improve accuracy of selection of the interpolation filter.

Specific content of the coding information of the to-be-decoded region is not limited in this disclosure, and may be understood as all coding information related to decoding of the to-be-decoded region, for example, the prediction mode, an inverse transform mode, an inverse quantization mode, the interpolation direction, the coding component, and the interpolation target.

In some embodiments, the coding information of the to-be-decoded region in one or more embodiments of this disclosure includes at least one of a prediction mode of the to-be-decoded region, an interpolation direction for interpolation, a to-be-decoded coding component, or an interpolation target.

For example, the prediction mode of the to-be-decoded region may include each mode in an intra prediction mode, each mode in an inter prediction mode, each mode in a hybrid prediction mode, and the like.

For example, the interpolation direction includes an x-direction and a y-direction.

For example, the coding component includes a luminance component and a chrominance component.

For example, the interpolation target includes determining a predicted value (for example, interpolation filtering is performed on the reference region of the to-be-decoded region, to determine a predicted value of the to-be-decoded region), and determining a gradient (for example, gradients of the forward reference block and the backward reference block in the x-direction or the y-direction are determined in the BIO).

In a possible implementation, an encoder side may write an index or indication information of the prediction mode of the to-be-decoded region into the bitstream. In this way, the decoder side may obtain the prediction mode of the to-be-decoded region by decoding the bitstream.

In a possible implementation, the encoder side may write the interpolation direction of the to-be-decoded region into the bitstream. For example, if interpolation is performed only in the x-direction of the to-be-decoded region and no interpolation is performed in the y-direction, the encoder side may write indication information of the interpolation direction into the bitstream, to indicate that the interpolation is performed only in the x-direction and no interpolation is performed in the y-direction. On the contrary, if interpolation is performed only in the y-direction of the to-be-decoded region and no interpolation is performed in the x-direction, the encoder side may write indication information of the interpolation direction into the bitstream, to indicate that the interpolation is performed only in the y-direction and no interpolation is performed in the x-direction. For another example, if the interpolation is performed in both the x-direction and the y-direction of the to-be-decoded region, the encoder side may write the indication information of the interpolation direction into the bitstream, to indicate that the interpolation is performed in both the x-direction and the y-direction. In some embodiments, the encoder side and the decoder side may predefine that interpolation is performed in the x-direction and/or y-direction.

In a possible implementation, the encoder side encodes the luminance component and the chrominance component separately. Based on this, the encoder side indicates, in the bitstream, whether information included in the bitstream is information corresponding to the luminance component or information corresponding to the chrominance component. In this way, the decoder side may obtain, by decoding the bitstream, whether the luminance component or the chrominance component of the to-be-decoded region is currently to be decoded.

In a possible implementation, the interpolation target may be derived through the prediction mode of the to-be-decoded region. For example, the decoder side decodes the bitstream, determines that the prediction mode of the to-be-decoded region is the inter prediction mode and a non-BIO mode. In addition, the decoder side obtains, by decoding the bitstream, that motion vector precision corresponding to the to-be-decoded region is a sub-pixel, so that the decoder side may determine that the interpolation target is to determine the predicted value. If the decoder side decodes the bitstream and determines that the prediction mode of the to-be-decoded region is the BIO mode, the decoder side may determine that the interpolation target is to determine the gradient.

In an example, the coding information of the foregoing to-be-decoded region may only include any one of the prediction mode, the interpolation direction, the coding component, or the interpolation target. For example, the coding information of the to-be-decoded region includes the prediction mode, and the prediction mode is a prediction mode 1. In this way, the decoder side may determine a target interpolation filter from interpolation filters corresponding to the prediction mode 1.

In an example, the coding information of the foregoing to-be-decoded region may include any two or three of the prediction mode, the interpolation direction, the coding component, and the interpolation target. For example, the coding information of the to-be-decoded region includes the prediction mode and the interpolation direction, and the prediction mode is the prediction mode 1, and the interpolation direction is the x-direction. In this way, the decoder side may determine a target interpolation filter from interpolation filters corresponding to the prediction mode 1 and the x-direction.

In an example, the coding information of the foregoing to-be-decoded region may include the prediction mode, the interpolation direction, the coding component, and the interpolation target. For example, the coding information of the to-be-decoded region includes that the prediction mode is the prediction mode 1, the interpolation direction is the x-direction, the coding component is the luminance component, and the interpolation target is to determine the predicted value of the to-be-decoded region. In this way, the decoder side may determine a target interpolation filter from interpolation filters corresponding to the prediction mode, the interpolation direction, the coding component, and the interpolation target.

In some embodiments, the decoder side may further obtain at least one of the prediction mode, the interpolation direction, the coding component, or the interpolation target corresponding to the to-be-decoded region in another manner.

After determining the coding information of the to-be-decoded region, the decoder side performs the following operation of S102.
S102: Determine a target interpolation filter corresponding to the to-be-decoded region based on the coding information. For example, a target interpolation filter corresponding to the to-be-decoded region is determined, by processing circuitry, from a plurality of candidate interpolation filters based on the coding information, the plurality of candidate interpolation filters having different filter taps.

In one or more embodiments of this disclosure, the decoder side determines the target interpolation filter corresponding to the to-be-decoded region from interpolation filters each having a different quantity of taps based on the coding information of the to-be-decoded region. Performance differences of the interpolation filters each having a different quantity of taps in different encoding modes, different coding components, different interpolation directions, and different interpolation targets are fully considered, thereby improving accuracy of selection of the target interpolation filter.

A specific manner in which the decoder side determines the target interpolation filter corresponding to the to-be-decoded region based on the at least one of the prediction mode, the interpolation direction, the coding component, or the interpolation target is not limited in this disclosure.

For example, interpolation filters corresponding to different prediction modes, interpolation filters corresponding to different interpolation directions, interpolation filters corresponding to different coding components, and interpolation filters corresponding to different interpolation targets are preset in one or more embodiments of this disclosure. In this way, the decoder side may determine the target interpolation filter corresponding to the to-be-decoded region from interpolation filters respectively corresponding to the prediction mode, the interpolation direction, the coding component, and the interpolation target of the to-be-decoded region.

In some embodiments, the foregoing S102 includes the following operations of S102-A1 to S102-A3:
S102-A1: Determine a plurality of candidate interpolation filters based on the coding information.
S102-A2: Decode the bitstream, to obtain first indication information of the target interpolation filter, the first indication information being configured for indicating index information of the target interpolation filter in the plurality of candidate interpolation filters.
S102-A3: Select the target interpolation filter from the plurality of candidate interpolation filters based on the first indication information.

In the implementation, when determining the target interpolation filter corresponding to the to-be-decoded region based on the foregoing determined coding information of the to-be-decoded region, the decoder side first determines the plurality of candidate interpolation filters based on the coding information, and then selects, from the candidate interpolation filters, one interpolation filter as the target interpolation filter. In other words, in one or more embodiments of this disclosure, a plurality of candidate interpolation filters each having a different quantity of taps are determined based on the coding information, and then the target interpolation filter is selected from the plurality of candidate interpolation filters each having a different quantity of taps. The performance differences of the interpolation filters each having a different quantity of taps in different encoding modes, different coding components, different interpolation directions, and different interpolation targets are fully considered, thereby improving accuracy of determining the target interpolation filter.

A specific process in which the decoder side determines the plurality of candidate interpolation filters based on the coding information is described below.

In one or more embodiments of this disclosure, implementations of determining the plurality of candidate interpolation filters based on the coding information in the foregoing S102-A1 include at least the following:

In Implementation 1, the decoder side determines the plurality of candidate interpolation filters through the following operations of S102-A1-a1 and S102-A1-a2:
S102-A1-a1: Obtain preset candidate interpolation filters respectively corresponding to the at least one of the prediction mode, the interpolation direction, the coding component, or the interpolation target. For example, preset candidate interpolation filters are obtained, where the preset candidate interpolation filters include a respective subset of candidate interpolation filters corresponding to each one of the at least one of the prediction mode, the interpolation direction, the coding component, or the interpolation target.
S102-A1-a2: Determine the plurality of candidate interpolation filters based on the preset candidate interpolation filters.

In the implementation, the at least one of the prediction mode, the interpolation direction, the coding component, or the interpolation target in the coding information respectively corresponds to the preset candidate interpolation filters.

In an example, different prediction modes may correspond to different candidate interpolation filters. For example, the prediction mode 1 corresponds to m1 candidate interpolation filters, and a prediction mode 2 corresponds to m2 candidate interpolation filters. Respective quantities of taps of the m1 candidate interpolation filters are not completely consistent with respective quantities of taps of the m2 candidate interpolation filters. For example, the candidate interpolation filters corresponding to the BIO mode includes an 8-tap interpolation filter and a 12-tap interpolation filter. The candidate interpolation filters corresponding to the non-BIO mode includes a 6-tap interpolation filter and an 8-tap interpolation filter.

In an example, different interpolation directions may correspond to different candidate interpolation filters. For example, the x-direction corresponds to m3 candidate interpolation filters, and the y-direction corresponds to m4 candidate interpolation filters. Respective quantities of taps of the m3 candidate interpolation filters are not completely consistent with respective quantities of taps of the m4 candidate interpolation filters. For example, the candidate interpolation filters corresponding to the x (horizontal) direction include an 8-tap interpolation filter and a 12-tap interpolation filter, and the candidate interpolation filters corresponding to the y (vertical) direction include a 6-tap interpolation filter and an 8-tap interpolation filter.

In an example, different coding components may correspond to different candidate interpolation filters. For example, the luminance component corresponds to m5 candidate interpolation filters, and the chrominance component corresponds to m6 candidate interpolation filters. Respective quantities of taps of the m5 candidate interpolation filters are not completely consistent with respective quantities of taps of the m6 candidate interpolation filters. For example, the candidate interpolation filters corresponding to the luminance component include an 8-tap interpolation filter and a 12-tap interpolation filter, and the candidate interpolation filters corresponding to the chrominance component include a 4-tap interpolation filter and a 6-tap interpolation filter.

For example, different interpolation targets may correspond to different candidate interpolation filters. For example, m7 candidate interpolation filters are applicable during determining of the predicted values, and m8 candidate interpolation filters are applicable during determining of the gradients. Respective quantities of taps of the m7 candidate interpolation filters are not completely consistent with respective quantities of taps of the m8 candidate interpolation filters.

In this way, the decoder side may determine the plurality of candidate interpolation filters based on the candidate interpolation filters respectively corresponding to the at least one of the prediction mode, the interpolation direction, the coding component, or the interpolation target of the to-be-decoded region.

For example, the decoder side selects, as the plurality of candidate interpolation filters, a preset quantity of candidate interpolation filters from the candidate interpolation filters respectively corresponding to the at least one of the prediction mode, the interpolation direction, the coding component, or the interpolation target of the to-be-decoded region. For example, assuming that the coding information of the to-be-decoded region includes the prediction mode and the coding component, the decoder side selects a preset quantity of (for example, n) candidate interpolation filters from the candidate interpolation filters respectively corresponding to the prediction mode and the coding component of the to-be-decoded region, to form a plurality of candidate interpolation filters. Referring to the foregoing example, assuming that the prediction mode of the to-be-decoded region is the prediction mode 1, and the coding component is a luminance component, the prediction mode 1 corresponds to m1 candidate interpolation filters, and the luminance component corresponds to m5 candidate interpolation filters. In this way, a preset quantity of candidate interpolation filters may be selected from m1+m5 candidate interpolation filters, i.e., the m1 candidate interpolation filters and the m5 candidate interpolation filters, to form the plurality of candidate interpolation filters.

For another example, the decoder side removes a duplicate interpolation filter from the selected prediction candidate interpolation filters, to obtain a plurality of candidate interpolation filters. For example, assuming that the coding information of the to-be-decoded region includes the prediction mode and the coding component, the prediction mode is a non-BIO mode, and the coding component is a luminance component. Assuming that the candidate interpolation filters corresponding to the non-BIO mode include a 6-tap interpolation filter and an 8-tap interpolation filter, the luminance component corresponds to the 8-tap interpolation filter and the 12-tap interpolation filter. One 8-tap interpolation filter is removed from the 4 interpolation filters, and the remaining 3 interpolation filters are respectively the 6-tap interpolation filter, the 8-tap interpolation filter, and the 12-tap interpolation filter. Then, the 3 interpolation filters, i.e., the 6-tap interpolation filter, the 8-tap interpolation filter, and the 12-tap interpolation filter, are determined as the plurality of candidate interpolation filters.

It may be learned from the foregoing description that Implementation 1 is that the decoder side selects the plurality of candidate interpolation filters from the preset candidate interpolation filters respectively corresponding to the at least one of the prediction mode, the interpolation direction, the coding component, or the interpolation target of the to-be-decoded region.

In some embodiments, the decoder side may further determine a plurality of candidate interpolation filters in a manner shown in the following Implementation 2.

In Implementation 2, the decoder side determines the plurality of candidate interpolation filters through the following operation of S102-A1-b:
S102-A1-b: Obtain selection strategies respectively corresponding to the at least one of the prediction mode, the interpolation direction, the coding component, or the interpolation target, and select the plurality of candidate interpolation filters from preset M interpolation filters based on the selection strategies, the M being a positive integer greater than 1. For example, a set of selection strategies is obtained, where the set of selection strategies includes a respective selection strategy corresponding to each one of the at least one of the prediction mode, the interpolation direction, the coding component, or the interpolation target. The plurality of candidate interpolation filters is selected from M preset interpolation filters based on the set of selection strategies.

In the implementation, M interpolation filters are preset, and the decoder side may select the plurality of interpolation filters from the preset M interpolation filters based on the at least one of the prediction mode, the interpolation direction, the coding component, or the interpolation target of the to-be-decoded region, to form a plurality of candidate interpolation filters. In some embodiments, the M interpolation filters have different quantities of taps.

In at least one aspect, the decoder side obtains the selection strategies respectively corresponding to the at least one of the prediction mode, the interpolation direction, the coding component, or the interpolation target of the to-be-decoded region. The selection strategies are the default for both the encoder side and the decoder side, or the encoder side transfers the selection strategies to the decoder side through a bitstream. In this way, the decoder side may select the plurality of candidate interpolation filters from the preset M interpolation filters based on the selection strategies.

In the implementation, the selection strategies respectively corresponding to the at least one of the prediction mode, the interpolation direction, the coding component, or the interpolation target of the to-be-decoded region may be the same, different, or partially the same and partially different.

For example, assuming that the coding information of the to-be-decoded region includes the prediction mode and the coding component, the prediction mode corresponds to a selection strategy 1, and the coding component corresponds to a selection strategy 2. In this way, the decoder side may select one or more interpolation filters from the M interpolation filters based on the selection strategy 1. In addition, the decoder side may select one or more interpolation filters from the M interpolation filters based on the selection strategy 2. Further, the decoder side obtains the plurality of candidate interpolation filters based on the one or more interpolation filters selected based on the strategy 1 and the one or more interpolation filters selected based on the strategy 2. For example, the decoder side determines, as the plurality of candidate interpolation filters, interpolation filters each having a different quantity of taps in the one or more interpolation filters selected based on the strategy 1 and the one or more interpolation filters selected based on the strategy 2.

In some embodiments, the decoder side may further determine a plurality of candidate interpolation filters in a manner shown in the following Implementation 3.

In Implementation 3, the decoder side determines the plurality of candidate interpolation filters through the following operation of S102-A1-c:
S102-A1-c: Obtain N candidate combinations formed by the M interpolation filters, decode the bitstream, to obtain second indication information, select a target candidate combination from the N candidate combinations based on the second indication information, and then determine interpolation filters included in the target candidate combination as the plurality of candidate interpolation filters, each of the candidate combinations including two or more of the M interpolation filters, the second indication information being configured for indicating the target candidate combination, and the N being a positive integer greater than 1. For example, N candidate combinations of two or more of the M preset interpolation filters are obtained, second indication information is obtained from the bitstream, a target candidate combination is selected from the N candidate combinations based on the second indication information, and interpolation filters in the target candidate combination are determined as the plurality of candidate interpolation filters.

In the implementation, M interpolation filters are preset, and the decoder side obtains N candidate combinations formed by the M interpolation filters. In some embodiments, the M interpolation filters have different quantities of taps.

In an example, the foregoing N candidate combinations are the default for both the encoder side and the decoder side. In other words, the decoder side has N candidate combinations stored therein, or the decoder side may combine the M interpolation filters by using the same rule as that of the encoder side, to obtain the N candidate combinations.

In an example, the foregoing N candidate combinations are indicated by the encoder side to the decoder side. For example, the encoder side writes the determined N candidate combinations into the bitstream. The decoder side obtains the N candidate combinations by decoding the bitstream.

Specific combination forms of the N candidate combinations are not limited in this disclosure.

In a possible implementation, interpolation filters included in different candidate combinations in the foregoing N candidate combinations are randomly distributed. In some examples, the interpolation filters in each candidate combination of the N candidate combinations are randomly selected from the M preset interpolation filters. For example, it is assumed that the M interpolation filters include 5 interpolation filters each having a different quantity of taps, which are a 4-tap interpolation filter, a 6-tap interpolation filter, an 8-tap interpolation filter, a 12-tap interpolation filter, and a 16-tap interpolation filter. The N candidate combinations formed by the 5 interpolation filters each having a different quantity of taps are {6-tap interpolation filter, 8-tap interpolation filter, 12-tap interpolation filter}, {2-tap interpolation filter, 4-tap interpolation filter, 6-tap interpolation filter}, {4-tap interpolation filter, 6-tap interpolation filter, 8-tap interpolation filter, 12-tap interpolation filter}, and the like. For example, the N candidate combinations are shown in Table 1:

TABLE 1

| Index | Bit | Meaning |
|---|---|---|
| 0 | 00 | Candidate combinations: {6-tap interpolation filter, 8-tap interpolation |
| | | filter, 12-tap interpolation filter} |
| 1 | 01 | Candidate combinations: {2-tap interpolation filter, 4-tap interpolation |
| | | filter, 6-tap interpolation filter} |
| 2 | 10 | Candidate combinations: {4-tap interpolation filter, 6-tap interpolation |
| | | filter, 8-tap interpolation filter, 12-tap interpolation filter} |
| . . . | . . . | . . . |

In a possible implementation, a quantity of interpolation filters included in each of the N candidate combinations progressively increases, and quantities of taps of the interpolation filters included in each candidate combination successively increase. In some examples, the quantity of interpolation filters in each candidate combination of the N candidate combinations increases while a maximum quantity of taps of the interpolation filters in each candidate combination of the N candidate combinations increases. For example, it is assumed that the M interpolation filters include 6 interpolation filters each having a different quantity of taps, which are a 2-tap interpolation filter, a 4-tap interpolation filter, a 6-tap interpolation filter, an 8-tap interpolation filter, a 12-tap interpolation filter, and a 16-tap interpolation filter. The N candidate combinations formed by the 6 interpolation filters each having a different quantity of taps include: {2-tap interpolation filter, 4-tap interpolation filter}, {2-tap interpolation filter, 4-tap interpolation filter, 6-tap interpolation filter}, {2-tap interpolation filter, 4-tap interpolation filter, 6-tap interpolation filter, 8-tap interpolation filter}, {2-tap interpolation filter, 4-tap interpolation filter, 6-tap interpolation filter, 8-tap interpolation filter, 12-tap interpolation filter}, {2-tap interpolation filter, 4-tap interpolation filter, 6-tap interpolation filter, 8-tap interpolation filter, 12-tap interpolation filter, 16-tap interpolation filter}, and the like. For example, the N candidate combinations are shown in Table 2:

TABLE 2

| Index | Bit | Meaning |
|---|---|---|
| 0 | 000 | No interpolation filter is used |
| 1 | 010 | The first 1 interpolation filter (with 2 taps) is used |
| 2 | 011 | The first 2 interpolation filters (with 2 taps and 4 taps) are used |
| 3 | 100 | The first 3 interpolation filters (with 2 taps, 4 taps, and 6 taps) are used |
| 4 | 101 | The first 4 interpolation filters (with 2 taps, 4 taps, 6 taps, and 8 taps) are used |
| 5 | 110 | The first 5 interpolation filters (with 2 taps, 4 taps, 6 taps, 8 taps, 12 taps) |
| | | are used |
| 6 | 111 | The first 6 interpolation filters (with 2 taps, 4 taps, 6 taps, 8 taps, 12 taps, |
| | | and 16 taps) are used |

In a possible implementation, the quantity of interpolation filters included in each candidate combination of the N candidate combinations gradually increases, and the quantities of taps of the interpolation filters included in each candidate combination sequentially decrease. In some examples, the quantity of interpolation filters in each candidate combination of the N candidate combinations increases while a minimum quantity of taps of the interpolation filters in each candidate of the N combination candidate combinations decreases. For example, it is assumed that the M interpolation filters include 6 interpolation filters each having a different quantity of taps, which are a 2-tap interpolation filter, a 4-tap interpolation filter, a 6-tap interpolation filter, an 8-tap interpolation filter, a 12-tap interpolation filter, and a 16-tap interpolation filter. The N candidate combinations formed by the 6 interpolation filters each having a different quantity of taps include: {12-tap interpolation filter, 16-tap interpolation filter}, {8-tap interpolation filter, 12-tap interpolation filter, 16-tap interpolation filter}, {6-tap interpolation filter, 8-tap interpolation filter, 12-tap interpolation filter, 16-tap interpolation filter}, {4-tap interpolation filter, 6-tap interpolation filter, 8-tap interpolation filter, 12-tap interpolation filter, 16-tap interpolation filter}, {2-tap interpolation filter, 4-tap interpolation filter, 6-tap interpolation filter, 8-tap interpolation filter, 12-tap interpolation filter, 16-tap interpolation filter}, and the like. For example, the N candidate combinations are shown in Table 3:

TABLE 3

| Index | Bit | Meaning |
|---|---|---|
| 0 | 000 | No interpolation filter is used |
| 1 | 010 | The last 1 interpolation filter (with 16 taps) is used |
| 2 | 011 | The last 2 interpolation filters (with 12 taps and 16 taps) are used |
| 3 | 100 | The last 3 interpolation filters (with 8 taps, 12 taps, and 16 taps) are used |
| 4 | 101 | The last 4 interpolation filters (with 6 taps, 8 taps, 12 taps, and 16 taps) are used |
| 5 | 110 | The last 5 interpolation filters (with 4 taps, 6 taps, 8 taps, 12 taps, 16 taps) |
| | | are used |
| 6 | 111 | The last 6 interpolation filters (with 2 taps, 4 taps, 6 taps, 8 taps, 12 taps, |
| | | and 16 taps) are used |

In Implementation 3, the encoder side obtains N candidate combinations when determining the plurality of candidate interpolation filters, and selects a target candidate combination from the N candidate combinations. For example, the encoder side selects one target candidate combination from the N candidate combinations based on a rate-distortion cost, and then determines interpolation filters included in the target candidate combination as the plurality of candidate interpolation filters. In addition, the encoder side writes second indication information into the bitstream. The second indication information is configured for indicating the target candidate combination. For example, the second indication information includes an index of the target candidate combination in the N candidate combinations. For example, the second indication information includes an index 100. In this way, the decoder side may obtain the second indication information by decoding the bitstream, and then select the target candidate combination from the foregoing obtained N candidate combinations based on the second indication information. For example, the second indication information includes the index 100 of the target candidate combination in the N candidate combinations. In this way, the decoder side may select the target candidate combination from the foregoing obtained N candidate combinations based on the index 100. For example, the foregoing N candidate combinations are shown in Table 3. The candidate combination corresponding to the index 100 includes 3 interpolation filters with 8, 12, and 16 taps, and then the 3 interpolation filters are used as the plurality of candidate interpolation filters.

As described above, the decoder side may determine the plurality of candidate interpolation filters based on the coding information of the to-be-decoded region in the foregoing manner.

Specific implementation processes of the foregoing S102-A2 and S102-A3 are described below.

The specific implementation order of the foregoing S102-A2 and S102-A1 is not limited in this disclosure. For example, the foregoing S102-A2 may be performed before the foregoing S102-A1, or performed after the foregoing S102-A1, or performed simultaneously with the foregoing S102-A1.

In one or more embodiments of this disclosure, when determining the target interpolation filter, the encoder side determines the plurality of candidate interpolation filters based on the coding information of the to-be-encoded region, and then selects a candidate interpolation filter from the plurality of candidate interpolation filters as the target interpolation filter. For example, the encoder side selects the target interpolation filter from the plurality of candidate interpolation filters based on respective rate-distortion costs of the plurality of candidate interpolation filters. Next, the encoder side writes the first indication information into the bitstream. The first indication information is configured for indicating index information of the target interpolation filter in the plurality of candidate interpolation filters. In this way, when determining the target interpolation filter, the decoder side determines the plurality of candidate interpolation filters through the foregoing operations and decodes the bitstream simultaneously, to obtain first indication information, and then selects the target interpolation filter from the plurality of candidate interpolation filters based on the first indication information.

In some embodiments, the first indication information includes a flag bit array or a plurality of flag bits, and the flag bit array or the plurality of flag bits are configured for indicating the coding information and the target interpolation filter. In this case, the decoder side obtains the first indication information by decoding the bitstream, and then obtains the coding information of the to-be-decoded region based on the first indication information. In some examples, the bitstream is decoded to obtain the first indication information that includes a flag bit array or a plurality of flag bits indicating the coding information and the target interpolation filter. In some examples, the coding information of the to-be-decoded region is obtained based on the first indication information.

In an example, the first indication information indicates the prediction mode, the coding component, and the target interpolation filter. In this case, the first indication information includes parsing a flag bit array Flag1[A][I] (A and I are both positive integers), where A represents a coding component, for example, A=0 represents a luminance component, and A=1 represents a chrominance component; I represents the prediction mode, for example, I=0 represents a mode 1, and I=1 represents a mode 2; and Flag1[A][I] represents index information of a target interpolation filter of a component A in the prediction mode I. For example, the first indication information and the meaning thereof are shown in Table 4:

TABLE 4

| | Prediction | | Quantity | | |
|---|---|---|---|---|---|
| Flag bit array | mode | Component | of taps | Bit | Meaning |
| Flag1[0] [0] | Mode 1 | Luminance | 8 | 0 | An 8-tap interpolation |
| | | | | | filter is used |
| | | | 12 | 1 | A 12-tap interpolation |
| | | | | | filter is used |
| Flag1[1] [0] | | Chrominance | 4 | 0 | A 4-tap interpolation |
| | | | | | filter is used |
| | | | 6 | 1 | A 6-tap interpolation |
| | | | | | filter is used |
| Flag1[0] [1] | Mode 2 | Luminance | 12 | 0 | A 12-tap interpolation |
| | | | | | filter is used |
| | | | 16 | 1 | A 16-tap interpolation |
| | | | | | filter is used |
| Flag1[1] [1] | | Chrominance | 6 | 0 | A 6-tap interpolation |
| | | | | | filter is used |
| | | | 10 | 1 | A 10-tap interpolation |
| | | | | | filter is used |
| . . . | . . . | . . . | . . . | . . . | . . . |

As shown in Table 4, assuming that the coding information of the to-be-decoded region includes the prediction mode and the coding component, the prediction mode is the mode 1, and the coding component is the chrominance component, the plurality of candidate interpolation filters determined by the decoder side based on the prediction mode 1 and the chrominance component include the 4-tap interpolation filter and the 6-tap interpolation filter. In this way, if the first indication information obtained by the decoder side by decoding the bitstream includes the flag bit array Flag1[1][0]=1, it is determined that the target interpolation filter is the 6-tap interpolation filter. If the first indication information includes the flag bit array Flag1[1][0]=0, it is determined that the target interpolation filter is the 4-tap interpolation filter.

In an example, the first indication information indicates the interpolation direction, the coding component, and the target interpolation filter. In this case, the first indication information includes parsing a flag bit array Flag2[A][B] (A and B are both positive integers), where A represents a coding component, for example, A=0 represents a luminance component, and A=1 represents a chrominance component; B represents the interpolation direction, for example, B=0 represents an x-direction, and B=1 represents a y-direction; and Flag2[A][B] represents index information of a target interpolation filter of a component A in the interpolation direction B. For example, the first indication information and the meaning thereof are shown in Table 5:

TABLE 5

| | Interpolation | | Quantity | | |
|---|---|---|---|---|---|
| Flag bit array | direction | Component | of taps | Bit | Meaning |
| Flag2[0] [0] | x-direction | Luminance | 8 | 0 | An 8-tap interpolation |
| | | | | | filter is used |
| | | | 12 | 1 | A 12-tap interpolation |
| | | | | | filter is used |
| Flag2[1] [0] | | Chrominance | 4 | 0 | A 4-tap interpolation |
| | | | | | filter is used |
| | | | 6 | 1 | A 6-tap interpolation |
| | | | | | filter is used |
| Flag2[0] [1] | y-direction | Luminance | 12 | 0 | A 12-tap interpolation |
| | | | | | filter is used |
| | | | 16 | 1 | A 16-tap interpolation |
| | | | | | filter is used |
| Flag2[1] [1] | | Chrominance | 6 | 0 | A 6-tap interpolation |
| | | | | | filter is used |
| | | | 10 | 1 | A 10-tap interpolation |
| | | | | | filter is used |

As shown in Table 5, assuming that the coding information of the to-be-decoded region includes the interpolation direction and the coding component, the interpolation direction is the y-direction, and the coding component is a chrominance component, the plurality of candidate interpolation filters determined by the decoder side based on the interpolation direction y-direction and the chrominance component of the to-be-decoded region include the 6-tap interpolation filter and the 10-tap interpolation filter. In this way, if the first indication information obtained by the decoder side by decoding the bitstream includes the flag bit array Flag2[1][1]=0, it is determined that the target interpolation filter is the 6-tap interpolation filter. If the first indication information includes the flag bit array Flag2[1][1]=1, it is determined that the target interpolation filter is the 10-tap interpolation filter.

In an example, the first indication information indicates the interpolation target, the coding component, and the target interpolation filter. In this case, the first indication information includes parsing a flag bit array Flag3[A][D] (A and D are both positive integers), where A represents a coding component, for example, A=0 represents a luminance component, and A=1 represents a chrominance component; D represents the interpolation target, for example, D=0 represents that the interpolation target is to determine a predicted value, and D=1 represents that the interpolation target is to determine a gradient; and Flag3[A][D] represents index information of a target interpolation filter of a component A for the interpolation target D. For example, the first indication information and the meaning thereof are shown in Table 6:

TABLE 6

| | Interpolation | | Quantity | | |
|---|---|---|---|---|---|
| Flag bit array | content | Component | of taps | Bit | Meaning |
| Flag3[0][0] | Predicted value | Luminance | 8 | 0 | An 8-tap interpolation |
| | | | | | filter is used |
| | | | 12 | 1 | A 12-tap interpolation |
| | | | | | filter is used |
| Flag3 [0][1] | | Chrominance | 4 | 0 | A 4-tap interpolation |
| | | | | | filter is used |
| | | | 6 | 1 | A 6-tap interpolation |
| | | | | | filter is used |
| Flag3 [1][0] | Gradient | Luminance | 8 | 0 | An 8-tap interpolation |
| | | | | | filter is used |
| | | | 12 | 1 | A 12-tap interpolation |
| | | | | | filter is used |
| Flag3[1][1] | | Chrominance | 6 | 0 | A 6-tap interpolation |
| | | | | | filter is used |
| | | | 8 | 1 | An 8-tap interpolation |
| | | | | | filter is used |
| . . . | . . . | . . . | . . . | . . . | . . . |

As shown in Table 6, assuming that the coding information of the to-be-decoded region includes the interpolation target and the coding component, the interpolation target is to determine the predicted value, and the coding component is a chrominance component, the plurality of candidate interpolation filters determined by the decoder side based on the interpolation target (namely, determining the predicted value) and the chrominance component of the to-be-decoded region include the 4-tap interpolation filter and the 6-tap interpolation filter. In this way, if the first indication information obtained by the decoder side by decoding the bitstream includes the flag bit array Flag3[0][1]=0, it is determined that the target interpolation filter is the 4-tap interpolation filter. If the first indication information includes the flag bit array Flag3[0][1]=1, it is determined that the target interpolation filter is the 6-tap interpolation filter.

In the implementation, the decoder side determines a plurality of candidate interpolation filters each having a different quantity of taps based on at least one of the prediction mode, the interpolation direction, the coding component, or the interpolation target corresponding to the to-be-decoded region, and then selects the target interpolation filter from the plurality of candidate interpolation filters each having a different quantity of taps.

In some embodiments, the decoder side may determine, as the target interpolation filter corresponding to the to-be-decoded region, a default interpolation filter corresponding to the at least one of the prediction mode, the interpolation direction, the coding component, or the interpolation target corresponding to the to-be-decoded region.

In an example 1, the decoder side determines the target interpolation filter based on the prediction mode, the coding component, and the interpolation target of the to-be-decoded region.

For example, both the encoder side and the decoder side are configured by default to use a specific N1-tap interpolation filter for the luminance and/or chrominance components targeting j1 interpolation targets in i prediction modes, and use a specific N2-tap interpolation filter for the luminance and/or chrominance components targeting j2 interpolation content in the remaining I-i prediction modes, where i, j1, j2, N1, and N2 are all integers, and N1N2.

For example, an n1-tap interpolation filter is determined as the target interpolation filter if the prediction mode of the to-be-decoded region is a BIO prediction mode, the coding component is a luminance component, and the interpolation target is to determine gradients of a forward prediction block and a backward prediction block of the to-be-decoded region in an x-direction and a y-direction;
an n2-tap interpolation filter is determined as the target interpolation filter if the prediction mode of the to-be-decoded region is the BIO prediction mode, the coding component is the luminance component, and the interpolation target is to determine the predicted values of the to-be-decoded region in the x-direction and the y-direction;
an n3-tap interpolation filter is determined as the target interpolation filter if the prediction mode of the to-be-decoded region is the BIO prediction mode, the coding component is the chrominance component, and the interpolation target is to determine the predicted values of the to-be-decoded region in the x-direction and the y-direction;
an n4-tap interpolation filter is determined as the target interpolation filter if the prediction mode of the to-be-decoded region is a non-BIO prediction mode, the coding component is the luminance component, and the interpolation target is to determine the predicted values of the to-be-decoded region in the x-direction and the y-direction; and
an n5-tap interpolation filter is determined as the target interpolation filter if the prediction mode of the to-be-decoded region is the non-BIO prediction mode, the coding component is the chrominance component, and the interpolation target is to determine the predicted values of the to-be-decoded region in the x-direction and the y-direction;
n1, n2, n3, n4, and n5 being all positive integers.

Specific values of the n1, n2, n3, n4, and n5 are not limited in this disclosure.

In a possible implementation, n1 is not equal to n2.

In an example, n1=8, n2=12, n3=6, n4=12, and n5=6.

A specific embodiment is shown in Table 7:

TABLE 7

| Prediction mode | Component | Quantity of taps |
|---|---|---|
| BIO mode | Luminance | A gradient gradXL[i][j] in the x-direction and a gradient |
| | | gradYL[i][j] in the y-direction are calculated through an 8-tap |
| | | filter, and interpolation calculation of the predicted value in the |
| | | y-x-direction and interpolation for the predicted value in the |
| | | direction is performed through a 12-tap filter |
| | Chrominance | Interpolation calculation of predicted values in the x-direction |
| | | and the y-direction is performed through a 6-tap filter |
| Non-BIO mode | Luminance | Interpolation calculation of predicted values in the x-direction |
| | | and the y-direction is performed through a 12-tap filter |
| | Chrominance | Interpolation calculation of predicted values in the x-direction |
| | | and the y-direction is performed through a 6-tap filter |

It may be learned from the foregoing Table 7 that in one or more embodiments of this disclosure, in the BIO mode, a quantity of taps of an interpolation filter used for calculating the gradient is different from a quantity of taps of an interpolation filter used for calculating a pixel prediction value. For example, an 8-tap interpolation filter is used for calculating the gradient, and a 12-tap interpolation filter is used for calculating interpolation of the pixel prediction value.

In an example 2, the decoder side determines the target interpolation filter based on the prediction mode and the coding component of the to-be-decoded region.

For example, both the encoder side and the decoder side are configured by default to only use a specific N1-tap interpolation filter for the luminance and/or chrominance components in i prediction modes, and use a specific N2-tap interpolation filter for the luminance and/or chrominance components in the remaining I-i prediction modes (i, N1, and N2 are all integers, and N1/N2).

For example, if the prediction mode of the to-be-decoded region is the BIO prediction mode and the coding component is the luminance component, an m1-tap interpolation filter is determined as the target interpolation filter, and in this case, the decoder side uses the m1-tap interpolation filter to perform gradient calculation and interpolation of the predicted value;
if the prediction mode of the to-be-decoded region is the BIO prediction mode and the coding component is the chrominance component, an m2-tap interpolation filter is determined as the target interpolation filter, and in this case, the decoder side uses the m2-tap interpolation filter to perform interpolation calculation of the predicted value in the x-direction and the y-direction;
if the prediction mode of the to-be-decoded region is the non-BIO prediction mode and the coding component is the luminance component, an m3-tap interpolation filter is determined as the target interpolation filter, and in this case, the decoder side uses the m3-tap interpolation filter to perform interpolation calculation of the predicted values in the x-direction and the y-direction; and
if the prediction mode of the to-be-decoded region is the non-BIO prediction mode and the coding component is the chrominance component, an m4-tap interpolation filter is determined as the target interpolation filter, and in this case, the decoder side uses the m4-tap interpolation filter to perform interpolation calculation of the predicted values in the x-direction and the y-direction;
m1, m2, m3, and m4 being all positive integers.

Specific values of the m1, m2, m3, and m4 are not limited in this disclosure.

In an example, m1=8, m2=6, m3=12, and m4=6.

A specific embodiment is shown in Table 8:

TABLE 8

| Prediction mode | Component | Quantity of taps |
|---|---|---|
| BIO | Luminance | The calculation of the gradient gradXL[i][j] in the x-direction |
| | | and the gradient gradYL[i][j] in the y-direction, as well as the |
| | | interpolation calculation of the predicted value in the x-direction |
| | | and the predicted value in the y-direction, is performed through |
| | | an 8-tap interpolation filter |
| | Chrominance | Interpolation calculation of predicted values in the x-direction |
| | | and the y-direction is performed through a 6-tap filter |
| Non-BIO | Luminance | Interpolation calculation of predicted values in the x-direction |
| | | and the y-direction is performed through a 12-tap filter |
| | Chrominance | Interpolation calculation of predicted values in the x-direction |
| | | and the y-direction is performed through a 6-tap filter |

In an example 3, the decoder side determines the target interpolation filter based on the interpolation direction and the coding component.

For example, the encoder side and the decoder side are configured by default to use an N1-tap interpolation filter for interpolation of content such as predicted values and gradients of luminance and/or chrominance components in the x-direction, and use an N2-tap interpolation filter for interpolation of content such as predicted values and gradients of luminance and/or chrominance components in the y-direction (N1 and N2 are both positive integers, and N1≠N2).

For example, if the interpolation direction of the to-be-decoded region is the x-direction and the coding component is the luminance component, a k1-tap interpolation filter is determined as the target interpolation filter, and in this case, the decoder side uses the k1-tap interpolation filter to perform gradient calculation and interpolation of the predicted value;
if the interpolation direction of the to-be-decoded region is the x-direction and the coding component is the chrominance component, a k2-tap interpolation filter is determined as the target interpolation filter, and in this case, the decoder side uses the k2-tap interpolation filter to perform gradient calculation and interpolation of the predicted value;
if the interpolation direction of the to-be-decoded region is the x-direction and the coding component is the luminance component, a k3-tap interpolation filter is determined as the target interpolation filter, and in this case, the decoder side uses the k3-tap interpolation filter to perform gradient calculation and interpolation of the predicted value; and
if the interpolation direction of the to-be-decoded region is the y-direction and the coding component is the chrominance component, a k4-tap interpolation filter is determined as the target interpolation filter, and in this case, the decoder side uses the k4-tap interpolation filter to perform gradient calculation and interpolation of the predicted value;
k1, k2, k3, and k4 being all positive integers.

Specific values of the k1, k2, k3, and k4 are not limited in this disclosure.

In an example, k1=12, k2=6, k3=8, and k4=4.

A specific embodiment is shown in Table 9:

TABLE 9

| Direction | Component | Quantity of taps |
|---|---|---|
| x-direction | Luminance | A 12-tap filter is used for any |
| | | interpolation content such as the |
| | | predicted values and the gradients |
| | Chrominance | A 6-tap filter is used for any |
| | | interpolation content such as the |
| | | predicted values and the gradients |
| y-direction | Luminance | An 8-tap filter is used for any |
| | | interpolation content such as the |
| | | predicted values and the gradients |
| | Chrominance | A 4-tap filter is used for any |
| | | interpolation content such as the |
| | | predicted values and the gradients |

For example, the interpolation filters used in the x-direction and the y-direction may also be interchanged. To be specific, an interpolation filter with a smaller quantity of taps (for example, an 8-tap filter and a 4-tap filter) is used in the x-direction, and an interpolation filter with a larger quantity of taps (for example, a 12-tap filter and a 6-tap filter) is used in the y-direction.

In an example 4, the decoder side determines the target interpolation filter based on the coding component and a size of the to-be-decoded region.

For example, both the encoder side and the decoder side are configured by default to use the N1-tap interpolation filter within a size range, and use the N2-tap interpolation filter within another size range (N1 and N2 are both positive integers, and N1≠N2).

For example, if the coding component of the to-be-decoded region is the luminance component, and a scale of the to-be-decoded region is w<=W1 or h<=H1, an a1-tap interpolation filter is determined as the target interpolation filter, and in this case, the decoder side uses the a1-tap interpolation filter to perform gradient calculation and interpolation of predicted value;
if the coding component of the to-be-decoded region is the luminance component, and the scale of the to-be-decoded region is w>W1 and h>H1, an a2-tap interpolation filter is determined as the target interpolation filter, and in this case, the decoder side uses the a2-tap interpolation filter to perform gradient calculation and interpolation of the predicted value;
if the coding component of the to-be-decoded region is the chrominance component, and the scale of the to-be-decoded region is w<=W2 or h<=H2, an a3-tap interpolation filter is determined as the target interpolation filter, and in this case, the decoder side uses the a3-tap interpolation filter to perform gradient calculation and interpolation of the predicted value; and
if the coding component of the to-be-decoded region is the chrominance component, and when a scale of the to-be-decoded region is w>W2 and h>H2, an a4-tap interpolation filter is determined as the target interpolation filter, and in this case, the decoder side uses the a4-tap interpolation filter to perform gradient calculation and interpolation of predicted value;
a1, a2, a3, and a4 being all positive integers.

Specific values of the a1, a2, a3, and a4 are not limited in this disclosure.

In an example, a1=8, a2=12, a3=4, and a4=6.

A specific embodiment is shown in Table 10:

TABLE 10

| Component | Size | Quantity of taps |
|---|---|---|
| Luminance | w <= W1 or h <= H1 | Interpolation calculation in the x-direction and the |
| | | y-direction is performed through the 8-tap filter |
| | w > W1 and h > H1 | Interpolation calculation in the x-direction and the |
| | | y-direction is performed through the 12-tap filter |
| Chrominance | w <= W2 or h <= H2 | Interpolation calculation in the x-direction and the |
| | | y-direction is performed through the 4-tap filter |
| | w > W2 and h > H2 | Interpolation calculation in the x-direction and the |
| | | y-direction is performed through the 6-tap filter |

w and h represent block sizes of the to-be-decoded region in a current component, and W1, H1, W2, and H2 are all positive integers.

After determining the target interpolation filter based on the foregoing operations, the decoder side performs the following operation of S103.
S103: Determine a reference region of the to-be-decoded region, and perform interpolation on the reference region based on the target interpolation filter, to determine a predicted value of the to-be-decoded region. For example, a predicted value of the to-be-decoded region is determined, by the processing circuitry, through application of the target interpolation filter on a reference region.

The decoder side performs interpolation on the reference region of the to-be-decoded region by using the target interpolation filter after determining the target interpolation filter corresponding to the to-be-decoded region based on the foregoing operation, to determine the predicted value of the to-be-decoded region.

A sequence in which the decoder side determines the reference region of the to-be-decoded region and determines the target interpolation filter corresponding to the to-be-decoded region is not limited in this disclosure. In other words, the decoder side may first determine the target interpolation filter corresponding to the to-be-decoded region, and then determine the reference region of the to-be-decoded region. Alternatively, the decoder side may first determine the reference region of the to-be-decoded region, and then determine the target interpolation filter corresponding to the to-be-decoded region. Alternatively, the decoder side may determine the target interpolation filter corresponding to the to-be-decoded region while determining the reference region of the to-be-decoded region.

In one or more embodiments of this disclosure, the reference region of the to-be-decoded region may be a reference block or a reference frame. This is not limited in this disclosure. For a specific manner in which the decoder side determines the reference region of the to-be-decoded region, reference may be made to the description in the related art. Details are not described herein again.

Next, the decoder side performs interpolation on the reference region of the to-be-decoded region based on the foregoing determined target interpolation filter, and then determines the predicted value of the to-be-decoded region.

In an example, if the foregoing interpolation target is to perform interpolation on a pixel prediction value (i.e., to determine a predicted value), the decoder side uses the target interpolation filter to perform interpolation on the reference region of the to-be-decoded region, to obtain an interpolated reference region. Further, a prediction block of the to-be-decoded region is obtained from the interpolated reference region based on a motion vector corresponding to the to-be-decoded region.

In an example, if the prediction mode corresponding to the to-be-decoded region in one or more embodiments of this disclosure is BIO, the decoder side first uses a bidirectional prediction mode to determine a forward reference block and a backward reference block of the to-be-decoded region. Next, the target interpolation filter is sampled to perform interpolation on the forward reference block and the backward reference block, to determine gradients of the forward reference block and the backward reference block, and then corrects motion vectors corresponding to the forward reference block and the backward reference block based on the gradients, to obtain the predicted value of the to-be-decoded region.

In some embodiments, bit widths of filter coefficients of the foregoing interpolation filters each having a different quantity of taps in one or more embodiments of this disclosure may be different, and/or bit widths of filter coefficients of interpolation filters with the same quantity of taps may also be different.

In some embodiments, the embodiments of this disclosure further provide coefficients of interpolation filters with partially different quantities of taps. Details are as follows. An MV position may be understood as a position of a pixel point, and coefficients are filter coefficients. In some embodiments, an interpolation filter for determining a gradient is also referred to as a gradient filter or a gradient interpolation filter.

TABLE 11
Coefficients of an 8-tap gradient filter used in the BIO mode

| MV position | Coefficients |
|---|---|
| 0 | −4, 11, −39, −1, 41, −14, 8, −2 |
| 1/4 | −2, 6, −19, −31, 53, −12, 7, −2 |
| 1/2 | 0, −1, 0, −50, 50, 0, 1, 0 |
| 3/4 | 2, −7, 12, −53, 31, 19, −6, 2 |

TABLE 12
Coefficients of a 12-tap filter used in the BIO and non-BIO modes
except an AFFINE mode

| MV position | Coefficients |
|---|---|
| 0 | 0, 0, 0, 0, 0, 256, 0, 0, 0, 0, 0, 0 |
| 1/4 | −2, 5, −11, 21, −43, 230, 75, −29, 15, −8, 4, −1 |
| 1/2 | −2, 6, −13, 25, −50, 162, 162, −50, 25, −13, 6, −2 |
| 3/4 | −1, 4, −8, 15, −29, 75, 230, −43, 21, −11, 5, −2 |

TABLE 13
Coefficients of a 12-tap filter used in the AFFINE mode

| MV position | Coefficients |
|---|---|
| 0 | 0, 0, 0, 0, 0, 256, 0, 0, 0, 0, 0, 0 |
| 1/16 | −1, 2, −3, 6, −14, 254, 16, −7, 4, −2, 1, 0 |
| 2/16 | −1, 3, −7, 12, −26, 249, 35, −15, 8, −4, 2, 0 |
| 3/16 | −2, 5, −9, 17, −36, 241, 54, −22, 12, −6, 3, −1 |
| 4/16 | −2, 5, −11, 21, −43, 230, 75, −29, 15, −8, 4, −1 |
| 5/16 | −2, 6, −13, 24, −48, 216, 97, −36, 19, −10, 4, −1 |
| 6/16 | −2, 7, −14, 25, −51, 200, 119, −42, 22, −12, 5, −1 |
| 7/16 | −2, 7, −14, 26, −51, 181, 140, −46, 24, −13, 6, −2 |
| 8/16 | −2, 6, −13, 25, −50, 162, 162, −50, 25, −13, 6, −2 |
| 9/16 | −2, 6, −13, 24, −46, 140, 181, −51, 26, −14, 7, −2 |
| 10/16 | −1, 5, −12, 22, −42, 119, 200, −51, 25, −14, 7, −2 |
| 11/16 | −1, 4, −10, 19, −36, 97, 216, −48, 24, −13, 6, −2 |
| 12/16 | −1, 4, −8, 15, −29, 75, 230, −43, 21, −11, 5, −2 |
| 13/16 | −1, 3, −6, 12, −22, 54, 241, −36, 17, −9, 5, −2 |
| 14/16 | 0, 2, −4, 8, −15, 35, 249, −26, 12, −7, 3, −1 |
| 15/16 | 0, 1, −2, 4, −7, 16, 254, −14, 6, −3, 2, −1 |

TABLE 14
Coefficients of a 6-tap filter used in the BIO and non-BIO
modes except an AFFINE mode

| MV position | Coefficients |
|---|---|
| 0 | 0, 0, 256, 0, 0, 0 |
| 1/8 | 4, −21, 248, 33, −10, 2 |
| 2/8 | 8, −35, 227, 73, −22, 5 |
| 3/8 | 10, −42, 196, 117, −34, 9 |
| 4/8 | 10, −40, 158, 158, −40, 10 |
| 5/8 | 9, −34, 117, 196, −42, 10 |
| 6/8 | 5, −22, 73, 227, −35, 8 |
| 7/8 | 2, −10, 33, 248, −21, 4 |

TABLE 15
Coefficients of a 6-tap filter used in the AFFINE mode

| MV position | Coefficients |
|---|---|
| 0 | 0, 0, 256, 0, 0, 0 |
| 1/32 | 1, −6, 256, 7, −2, 0 |
| 2/32 | 2, −11, 253, 15, −4, 1 |
| 3/32 | 3, −16, 251, 23, −6, 1 |
| 4/32 | 4, −21, 248, 33, −10, 2 |
| 5/32 | 5, −25, 244, 42, −12, 2 |
| 6/32 | 7, −30, 239, 53, −17, 4 |
| 7/32 | 7, −32, 234, 62, −19, 4 |
| 8/32 | 8, −35, 227, 73, −22, 5 |
| 9/32 | 9, −38, 220, 84, −26, 7 |
| 10/32 | 10, −40, 213, 95, −29, 7 |
| 11/32 | 10, −41, 204, 106, −31, 8 |
| 12/32 | 10, −42, 196, 117, −34, 9 |
| 13/32 | 10, −41, 187, 127, −35, 8 |
| 14/32 | 11, −42, 177, 138, −38, 10 |
| 15/32 | 10, −41, 168, 148, −39, 10 |
| 16/32 | 10, −40, 158, 158, −40, 10 |
| 17/32 | 10, −39, 148, 168, −41, 10 |
| 18/32 | 10, −38, 138, 177, −42, 11 |
| 19/32 | 8, −35, 127, 187, −41, 10 |
| 20/32 | 9, −34, 117, 196, −42, 10 |
| 21/32 | 8, −31, 106, 204, −41, 10 |
| 22/32 | 7, −29, 95, 213, −40, 10 |
| 23/32 | 7, −26, 84, 220, −38, 9 |
| 24/32 | 5, −22, 73, 227, −35, 8 |
| 25/32 | 4, −19, 62, 234, −32, 7 |
| 26/32 | 4, −17, 53, 239, −30, 7 |
| 27/32 | 2, −12, 42, 244, −25, 5 |
| 28/32 | 2, −10, 33, 248, −21, 4 |
| 29/32 | 1, −6, 23, 251, −16, 3 |
| 30/32 | 1, −4, 15, 253, −11, 2 |
| 31/32 | 0, −2, 7, 256, −6, 1 |

According to the video decoding method provided in one or more embodiments of this disclosure, a bitstream is decoded to obtain coding information of a to-be-decoded region, the coding information including at least one of a prediction mode, an interpolation direction, a coding component, or an interpolation target. A target interpolation filter corresponding to the to-be-decoded region is determined based on the coding information. A reference region of the to-be-decoded region is determined, and interpolation is performed on the reference region based on the target interpolation filter, to determine a predicted value of the to-be-decoded region. In other words, in one or more embodiments of this disclosure, a decoder side adaptively selects the target interpolation filter from interpolation filters each having a different quantity of taps based on coding information of a to-be-encoded region and coding information of a to-be-decoded region, for example, the prediction mode, the interpolation direction, the coding component, and the interpolation target, thereby improving accuracy of selection of the target interpolation filter. In this way, when the interpolation is performed on a reference region of the to-be-encoded region and the reference region of the to-be-decoded region based on the accurately selected target interpolation filter, to determine a predicted value of the to-be-encoded region and the predicted value of the to-be-decoded region, prediction effects of the to-be-encoded region and the to-be-decoded region may be improved, thereby improving performance of video encoding and decoding.

The decoder side is used as an example to describe the video decoding method of this disclosure above, and the encoder side is used as an example for description below.

FIG. 6 is a schematic flowchart of a video encoding method according to an embodiment of this disclosure. The embodiments of this disclosure are applied to the video encoder shown in FIG. 1 and FIG. 2 or executed by a processor. As shown in FIG. 6, the method in this disclosure includes the following operations.
Operation S201: Obtain coding information of a to-be-encoded region, and a reference region corresponding to the to-be-encoded region. For example, coding information of a to-be-encoded region is obtained, and a reference region corresponding to the to-be-encoded region is obtained, the coding information including at least one of a prediction mode, an interpolation direction, a coding component, or an interpolation target.

The coding information includes at least one of a prediction mode, an interpolation direction, an coding component, or an interpolation target.

A specific size and shape of the to-be-encoded region are not limited in this disclosure.

In some embodiments, the to-be-encoded region may be one or more to-be-encoded picture blocks in a to-be-encoded current frame, for example, may be one or more CTUs, one or more CUs, or one or more PUs. Certainly, the to-be-encoded region may further include an incomplete CTU, an incomplete CU, an incomplete PU, or the like. In an example, the to-be-encoded picture block may be referred to as a current block, a current to-be-encoded picture block, or the like.

In some embodiments, the to-be-encoded region may be a to-be-encoded current frame. In other words, the to-be-encoded region is a complete picture frame.

During video encoding, an encoder side determines a prediction mode of the to-be-encoded region when encoding the to-be-encoded region, determines a predicted value of the to-be-encoded region based on the prediction mode, and then determines a residual value of the to-be-encoded region based on the predicted value of the to-be-encoded region. Next, the residual value is transformed to obtain a transform coefficient, the transform coefficient is quantized to obtain a quantization coefficient, and finally the quantization coefficient is encoded to obtain a bitstream.

The embodiments of this disclosure mainly involve a prediction process of the to-be-encoded region.

In one or more embodiments of this disclosure, to improve prediction accuracy of the to-be-encoded region, an interpolation filter is used for performing interpolation on a reference region of the to-be-encoded region. However, currently, during selection of the interpolation filter, the coding information of the to-be-encoded region is not considered, resulting in inaccurate selection of the interpolation filter.

To resolve the foregoing technical problem, in one or more embodiments of this disclosure, a target interpolation filter of the to-be-encoded region is determined based on the coding information of the to-be-encoded region, to improve accuracy of selection of the interpolation filter.

Specific content of the coding information of the to-be-encoded region is not limited in this disclosure, and may be understood as all coding information related to encoding of the to-be-encoded region, for example, the prediction mode, a transform mode, a quantization mode, the interpolation direction, the coding component, and the interpolation target.

In some embodiments, the coding information of the to-be-encoded region in one or more embodiments of this disclosure includes at least one of a prediction mode of the to-be-encoded region, an interpolation direction for interpolation, a to-be-encoded coding component, or an interpolation target.

For example, the prediction mode of the to-be-encoded region may include each mode in an intra prediction mode, each mode in an inter prediction mode, each mode in a hybrid prediction mode, and the like.

For example, the interpolation direction includes an x-direction and a y-direction.

For example, the coding component includes a luminance component and a chrominance component.

For example, the interpolation target includes determining a predicted value (for example, pixel interpolation filtering is performed on the reference region of the to-be-encoded region, to determine a predicted value of the to-be-encoded region), and determining a gradient (for example, gradients of the forward reference block and the backward reference block in the x-direction or the y-direction are determined in the BIO).

In an example, the coding information of the foregoing to-be-encoded region may only include any one of the prediction mode, the interpolation direction, the coding component, or the interpolation target. For example, the coding information of the to-be-encoded region includes the prediction mode, and the prediction mode is a prediction mode 1. In this way, the encoder side may determine a target interpolation filter from interpolation filters corresponding to the prediction mode.

In an example, the coding information of the foregoing to-be-encoded region may include any two or three of the prediction mode, the interpolation direction, the coding component, and the interpolation target. For example, the coding information of the to-be-encoded region includes the prediction mode and the interpolation direction, and the prediction mode is the prediction mode 1, and the interpolation direction is the x-direction. In this way, the encoder side may determine a target interpolation filter from interpolation filters corresponding to the prediction mode 1 and the x-direction.

In an example, the coding information of the foregoing to-be-encoded region may include the prediction mode, the interpolation direction, the coding component, and the interpolation target. This is not limited in this disclosure. For example, the coding information of the to-be-encoded region includes that the prediction mode is the prediction mode 1, the interpolation direction is the x-direction, the coding component is the luminance component, and the interpolation target is to determine the predicted value of the to-be-encoded region. In this way, the encoder side may determine a target interpolation filter from interpolation filters corresponding to the prediction mode, the interpolation direction, the coding component, and the interpolation target.

In some embodiments, the encoder side may further obtain at least one of the prediction mode, the interpolation direction, the coding component, or the interpolation target corresponding to the to-be-encoded region in another manner.

In one or more embodiments of this disclosure, the reference region of the to-be-encoded region may be a reference block or a reference frame. This is not limited in this disclosure. For a specific manner in which the encoder side determines the reference region of the to-be-encoded region, reference may be made to the description in the related art. Details are not described herein again.

After determining the coding information of the to-be-encoded region, the encoder side performs the following operation of S202.
Operation S202: Determine a target interpolation filter corresponding to the to-be-encoded region based on the coding information. For example, a target interpolation filter corresponding to the to-be-encoded region is determined, by processing circuitry, from a plurality of candidate interpolation filters based on the coding information, the plurality of candidate interpolation filters having different filter taps.

In one or more embodiments of this disclosure, the encoder side determines the target interpolation filter corresponding to the to-be-encoded region from interpolation filters each having a different quantity of taps based on the coding information of the to-be-encoded region. Performance differences of the interpolation filters each having a different quantity of taps in different encoding modes, different coding components, different interpolation directions, and different interpolation targets are fully considered, thereby improving accuracy of selection of the target interpolation filter.

A specific manner in which the encoder side determines the target interpolation filter corresponding to the to-be-encoded region based on at least one of the prediction mode, the interpolation direction, the coding component, or the interpolation target is not limited in this disclosure.

For example, interpolation filters corresponding to different prediction modes, interpolation filters corresponding to different interpolation directions, interpolation filters corresponding to different coding components, and interpolation filters corresponding to different interpolation targets are preset in one or more embodiments of this disclosure. In this way, the encoder side may determine the target interpolation filter corresponding to the to-be-encoded region from interpolation filters respectively corresponding to the prediction mode, the interpolation direction, the coding component, and the interpolation target of the to-be-encoded region.

In some embodiments, the foregoing operation S202 includes the following operations of operation S202-A1 to operation S202-A2:
S202-A1: Determine a plurality of candidate interpolation filters based on the coding information.
S202-A2: Select the target interpolation filter from the plurality of candidate interpolation filters.

In the implementation, when determining the target interpolation filter corresponding to the to-be-encoded region based on the foregoing determined coding information of the to-be-encoded region, the encoder side first determines the plurality of candidate interpolation filters based on the coding information, and then selects, from the candidate interpolation filters, one interpolation filter as the target interpolation filter. In other words, in one or more embodiments of this disclosure, a plurality of candidate interpolation filters each having a different quantity of taps are determined based on the coding information, and then the target interpolation filter is selected from the plurality of candidate interpolation filters each having a different quantity of taps. The performance differences of the interpolation filters each having a different quantity of taps in different encoding modes, different coding components, different interpolation directions, and different interpolation targets are fully considered, thereby improving accuracy of determining the target interpolation filter.

A specific process in which the encoder side determines the plurality of candidate interpolation filters based on the coding information is described below.

In one or more embodiments of this disclosure, implementations of determining the plurality of candidate interpolation filters based on the coding information in the foregoing S202-A1 include at least the following:

In Implementation 1, the encoder side determines the plurality of candidate interpolation filters through the following operations of S202-A1-a1 and S202-A1-a2:
S202-A1-a1: Obtain preset candidate interpolation filters respectively corresponding to the at least one of the prediction mode, the interpolation direction, the coding component, or the interpolation target. For example, preset candidate interpolation filters are obtained, where the preset candidate interpolation filters include a respective subset of candidate interpolation filters corresponding to each one of the at least one of the prediction mode, the interpolation direction, the coding component, or the interpolation target.
S202-A1-a2: Determine the plurality of candidate interpolation filters based on the preset candidate interpolation filters.

In the implementation, the at least one of the prediction mode, the interpolation direction, the coding component, or the interpolation target in the coding information respectively corresponds to the preset candidate interpolation filters.

In an example, different prediction modes may correspond to different candidate interpolation filters. For example, the prediction mode 1 corresponds to m1 candidate interpolation filters, and a prediction mode 2 corresponds to m2 candidate interpolation filters. Respective quantities of taps of the m1 candidate interpolation filters are not completely consistent with respective quantities of taps of the m2 candidate interpolation filters. For example, the candidate interpolation filters corresponding to the BIO mode includes an 8-tap interpolation filter and a 12-tap interpolation filter. The candidate interpolation filters corresponding to the non-BIO mode includes a 6-tap interpolation filter and an 8-tap interpolation filter.

In an example, different interpolation directions may correspond to different candidate interpolation filters. For example, the x-direction corresponds to m3 candidate interpolation filters, and the y-direction corresponds to m4 candidate interpolation filters. Respective quantities of taps of the m3 candidate interpolation filters are not completely consistent with respective quantities of taps of the m4 candidate interpolation filters. For example, the candidate interpolation filters corresponding to the x (horizontal) direction include an 8-tap interpolation filter and a 12-tap interpolation filter, and the candidate interpolation filters corresponding to the y (vertical) direction include a 6-tap interpolation filter and an 8-tap interpolation filter.

In an example, different coding components may correspond to different candidate interpolation filters. For example, the luminance component corresponds to m5 candidate interpolation filters, and the chrominance component corresponds to m6 candidate interpolation filters. Respective quantities of taps of the m5 candidate interpolation filters are not completely consistent with respective quantities of taps of the m6 candidate interpolation filters. For example, the candidate interpolation filters corresponding to the luminance component include an 8-tap interpolation filter and a 12-tap interpolation filter, and the candidate interpolation filters corresponding to the chrominance component include a 4-tap interpolation filter and a 6-tap interpolation filter.

For example, different interpolation targets may correspond to different candidate interpolation filters. For example, m7 candidate interpolation filters are applicable during determining of the predicted values, and m8 candidate interpolation filters are applicable during determining of the gradients. Respective quantities of taps of the m7 candidate interpolation filters are not completely consistent with respective quantities of taps of the m8 candidate interpolation filters.

In this way, the encoder side may determine the plurality of candidate interpolation filters based on the candidate interpolation filters respectively corresponding to the at least one of the prediction mode, the interpolation direction, the coding component, or the interpolation target of the to-be-encoded region.

For example, the encoder side selects, as the plurality of candidate interpolation filters, a preset quantity of candidate interpolation filters from the candidate interpolation filters respectively corresponding to the at least one of the prediction mode, the interpolation direction, the coding component, or the interpolation target of the to-be-encoded region. For example, assuming that the coding information of the to-be-encoded region includes the prediction mode and the coding component, the encoder side selects a preset quantity of (for example, n) candidate interpolation filters from the candidate interpolation filters respectively corresponding to the prediction mode and the coding component of the to-be-encoded region, to form a plurality of candidate interpolation filters. Referring to the foregoing example, assuming that the prediction mode of the to-be-encoded region is the prediction mode 1, and the coding component is a luminance component, the prediction mode 1 corresponds to m1 candidate interpolation filters, and the luminance component corresponds to m5 candidate interpolation filters. In this way, a preset quantity of candidate interpolation filters may be selected from m1+m5 candidate interpolation filters, i.e., the m1 candidate interpolation filters and the m5 candidate interpolation filters, to form the plurality of candidate interpolation filters.

For another example, the encoder side removes a duplicate interpolation filter from the selected prediction candidate interpolation filters, to obtain a plurality of candidate interpolation filters. For example, assuming that the coding information of the to-be-encoded region includes the prediction mode and the coding component, the prediction mode is a non-BIO mode, and the coding component is a luminance component. Assuming that the candidate interpolation filters corresponding to the non-BIO mode include a 6-tap interpolation filter and an 8-tap interpolation filter, the luminance component corresponds to the 8-tap interpolation filter and the 12-tap interpolation filter. One 8-tap interpolation filter is removed from the 4 interpolation filters, and the remaining 3 interpolation filters are respectively the 6-tap interpolation filter, the 8-tap interpolation filter, and the 12-tap interpolation filter. Then, the 3 interpolation filters, i.e., the 6-tap interpolation filter, the 8-tap interpolation filter, and the 12-tap interpolation filter, are determined as the plurality of candidate interpolation filters.

It may be learned from the foregoing description that Implementation 1 is that the encoder side selects the plurality of candidate interpolation filters from the preset candidate interpolation filters respectively corresponding to the at least one of the prediction mode, the interpolation direction, the coding component, or the interpolation target of the to-be-encoded region.

In some embodiments, the encoder side may further determine a plurality of candidate interpolation filters in a manner shown in the following Implementation 2.

In Implementation 2, the encoder side selects a plurality of candidate interpolation filters from preset M interpolation filters.

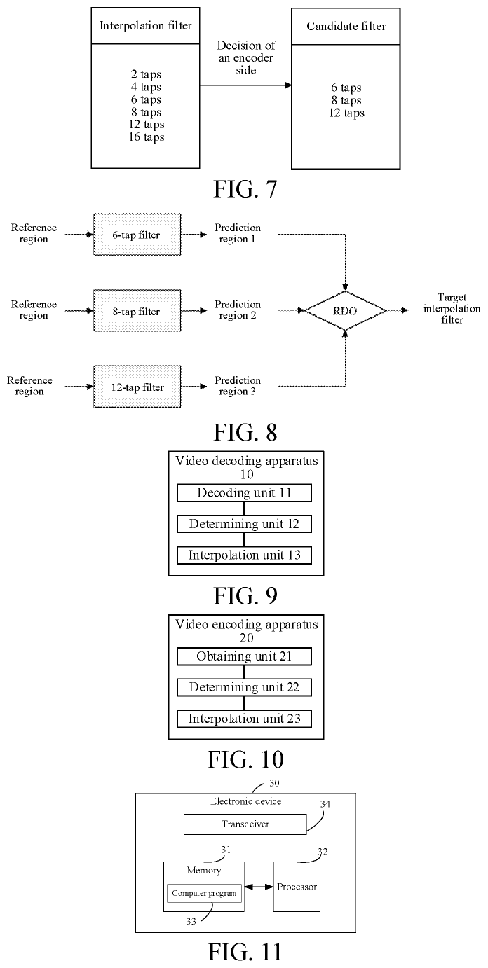

For example, as shown in FIG. 7, the M interpolation filters include 6 interpolation filters, which are a 2-tap interpolation filter, a 4-tap interpolation filter, a 6-tap interpolation filter, an 8-tap interpolation filter, a 12-tap interpolation filter, and a 16-tap interpolation filter. The encoder side may select, as the plurality of candidate interpolation filters, a plurality of interpolation filters from the 6 interpolation filters each having a different quantity of taps.

In an example of Implementation 2, the encoder side determines the plurality of candidate interpolation filters through the following operations of S202-A1-b1 and S202-A1-b2:
S202-A1-b1: Obtain selection strategies respectively corresponding to the at least one of the prediction mode, the interpolation direction, the coding component, or the interpolation target of the to-be-encoded region. For example, a set of selection strategies is obtained, where the set of selection strategies includes a respective selection strategy corresponding to each one of the at least one of the prediction mode, the interpolation direction, the coding component, or the interpolation target.
S202-A1-b2: Select the plurality of candidate interpolation filters from the preset M interpolation filters based on the selection strategies, M being a positive integer greater than 1. For example, the plurality of candidate interpolation filters is selected from M preset interpolation filters based on the set of selection strategies.

In the implementation, M interpolation filters are preset, and the encoder side may select the plurality of candidate interpolation filters from the preset M interpolation filters based on the at least one of the prediction mode, the interpolation direction, the coding component, or the interpolation target of the to-be-encoded region. In some embodiments, the M interpolation filters have different quantities of taps.

In at least one aspect, the encoder side obtains the selection strategies respectively corresponding to the at least one of the prediction mode, the interpolation direction, the coding component, or the interpolation target of the to-be-encoded region. The selection strategies are the default for both the encoder side and the decoder side. In this way, the encoder side may select the plurality of candidate interpolation filters from the preset M interpolation filters based on the selection strategies.

In the implementation, the selection strategies respectively corresponding to the at least one of the prediction mode, the interpolation direction, the coding component, or the interpolation target of the to-be-encoded region may be the same, different, or partially the same and partially different.

For example, assuming that the coding information of the to-be-encoded region includes the prediction mode and the coding component, the prediction mode corresponds to a selection strategy 1, and the coding component corresponds to a selection strategy 2. In this way, the encoder side may select one or more interpolation filters from the M interpolation filters based on the selection strategy 1. In addition, the encoder side may select one or more interpolation filters from the M interpolation filters based on the selection strategy 2. Further, the encoder side obtains the plurality of candidate interpolation filters based on the one or more interpolation filters selected based on the strategy 1 and the one or more interpolation filters selected based on the strategy 2. For example, the encoder side determines, as the plurality of candidate interpolation filters, interpolation filters each having a different quantity of taps in the one or more interpolation filters selected based on the strategy 1 and the one or more interpolation filters selected based on the strategy 2.

In some embodiments, the foregoing S202-A1-b2 includes the following operations of S202-A1-b21 and S202-A1-b22:
S202-A1-b21: Obtain N candidate combinations formed by the M interpolation filters, each of the candidate combinations including two or more of the M interpolation filters, and N being a positive integer greater than 1.
S202-A1-b22: Select a target candidate combination from the N candidate combinations based on the selection strategies, and determine interpolation filters included in the target candidate combination as the plurality of candidate interpolation filters.

In the implementation, M interpolation filters are preset, and the encoder side obtains N candidate combinations formed by the M interpolation filters. In some embodiments, the M interpolation filters have different quantities of taps.

In an example, the foregoing N candidate combinations are the default for both the encoder side and the decoder side. In other words, the encoder side has N candidate combinations stored therein, or the encoder side may combine the M interpolation filters by using the same rule as that of the decoder side, to obtain the N candidate combinations.

Specific combination forms of the N candidate combinations are not limited in this disclosure.

In a possible implementation, interpolation filters included in different candidate combinations in the foregoing N candidate combinations are randomly distributed. For example, it is assumed that the M interpolation filters include 5 interpolation filters each having a different quantity of taps, which are a 4-tap interpolation filter, a 6-tap interpolation filter, an 8-tap interpolation filter, a 12-tap interpolation filter, and a 16-tap interpolation filter. The N candidate combinations formed by the 5 interpolation filters each having a different quantity of taps are {6-tap interpolation filter, 8-tap interpolation filter, 12-tap interpolation filter}, {2-tap interpolation filter, 4-tap interpolation filter, 6-tap interpolation filter}, {4-tap interpolation filter, 6-tap interpolation filter, 8-tap interpolation filter, 12-tap interpolation filter}, and the like. For example, the N candidate combinations are shown in Table 1.

In a possible implementation, a quantity of interpolation filters included in each of the N candidate combinations progressively increases, and quantities of taps of the interpolation filters included in each candidate combination successively increase. For example, it is assumed that the M interpolation filters include 6 interpolation filters each having a different quantity of taps, which are a 2-tap interpolation filter, a 4-tap interpolation filter, a 6-tap interpolation filter, an 8-tap interpolation filter, a 12-tap interpolation filter, and a 16-tap interpolation filter. The N candidate combinations formed by the 6 interpolation filters each having a different quantity of taps include: {2-tap interpolation filter, 4-tap interpolation filter}, {2-tap interpolation filter, 4-tap interpolation filter, 6-tap interpolation filter}, {2-tap interpolation filter, 4-tap interpolation filter, 6-tap interpolation filter, 8-tap interpolation filter}, {2-tap interpolation filter, 4-tap interpolation filter, 6-tap interpolation filter, 8-tap interpolation filter, 12-tap interpolation filter}, {2-tap interpolation filter, 4-tap interpolation filter, 6-tap interpolation filter, 8-tap interpolation filter, 12-tap interpolation filter, 16-tap interpolation filter}, and the like. For example, the N candidate combinations are shown in Table 2.

In a possible implementation, the quantity of interpolation filters included in each candidate combination of the N candidate combinations gradually increases, and the quantities of taps of the interpolation filters included in each candidate combination sequentially decrease. For example, it is assumed that the M interpolation filters include 6 interpolation filters each having a different quantity of taps, which are a 2-tap interpolation filter, a 4-tap interpolation filter, a 6-tap interpolation filter, an 8-tap interpolation filter, a 12-tap interpolation filter, and a 16-tap interpolation filter. The N candidate combinations formed by the 6 interpolation filters each having a different quantity of taps include: {12-tap interpolation filter, 16-tap interpolation filter}, {8-tap interpolation filter, 12-tap interpolation filter, 16-tap interpolation filter}, {6-tap interpolation filter, 8-tap interpolation filter, 12-tap interpolation filter, 16-tap interpolation filter}, {4-tap interpolation filter, 6-tap interpolation filter, 8-tap interpolation filter, 12-tap interpolation filter, 16-tap interpolation filter}, {2-tap interpolation filter, 4-tap interpolation filter, 6-tap interpolation filter, 8-tap interpolation filter, 12-tap interpolation filter, 16-tap interpolation filter}, and the like. For example, the N candidate combinations are shown in Table 3.

Next, the encoder side selects a target candidate combination from the N candidate combinations based on the selection strategies respectively corresponding to the at least one of the prediction mode, the interpolation direction, the performing, by the processing circuitry, interpolation filtering on the reference region based on the target interpolation filter, to determine a predicted value of the to-be-encoded region coding component, or the interpolation target, and then determines interpolation filters included in the target candidate combination as the plurality of candidate interpolation filters. Specific content of the selection strategies is not limited in this disclosure.

In some embodiments, the encoder side writes second indication information into the bitstream after selecting the target candidate combination from the N candidate combinations based on the foregoing operations. The second indication information is configured for indicating the target candidate combination. For example, the second indication information includes an index of the target candidate combination in the N candidate combinations. For example, the second indication information includes an index 100. In this way, the decoder side may obtain the second indication information by decoding the bitstream, and then select the target candidate combination from the foregoing obtained N candidate combinations based on the second indication information.

As described above, the encoder side may determine the plurality of candidate interpolation filters based on the coding information of the to-be-encoded region in the foregoing manner. Next, the encoder side performs the foregoing operations of S202-A2, and selects the target interpolation filter from the plurality of candidate interpolation filters.

A specific manner in which the encoder side selects the target interpolation filter from the plurality of candidate interpolation filters is not limited in this disclosure.

In a possible implementation, the encoder side randomly selects the target interpolation filter from the plurality of candidate interpolation filters, or selects the target interpolation filter from the plurality of candidate interpolation filters based on some feature information (for example, information such as a scale) of the to-be-encoded region.

In a possible implementation, the foregoing S202-A2 includes the following operations of S202-A21 to S202-A23:
S202-A21: Perform interpolation on each of the plurality of candidate interpolation filters through the candidate interpolation filter based on the reference region, to obtain an interpolated prediction region.
S202-A22: Determine a rate-distortion cost corresponding to the candidate interpolation filter based on the interpolated prediction region.
S202-A23: Select the target interpolation filter from the plurality of candidate interpolation filters based on the rate-distortion cost corresponding to each of the plurality of candidate interpolation filters.

In the implementation, for each of the plurality of candidate interpolation filters, for example, an i^{th} candidate interpolation filter, the encoder side performs interpolation on the reference region by using the i^{th} candidate interpolation filter, to obtain an interpolated prediction region, and then determines the rate-distortion cost corresponding to the i^{th} candidate interpolation filter based on the interpolated prediction region. For a calculation process of the rate-distortion cost, reference may be made to descriptions in the related art. Details are not described herein again. In this way, the encoder side may determine the rate-distortion cost corresponding to each of the plurality of candidate interpolation filters, and then select the target interpolation filter from the plurality of candidate interpolation filters based on the rate-distortion cost corresponding to each of the plurality of candidate interpolation filters. For example, a candidate interpolation filter with a lowest rate-distortion cost from the plurality of candidate interpolation filters is determined as the target interpolation filter.

For example, as shown in FIG. 8, it is assumed that the plurality of candidate interpolation filters include 3 candidate interpolation filters, which are a 6-tap candidate interpolation filter, an 8-tap candidate interpolation filter, and a 12-tap candidate interpolation filter. The encoder side performs interpolation on the reference region of the to-be-encoded region respectively by using the 3 candidate interpolation filters, to obtain prediction regions respectively corresponding to the 3 candidate interpolation filters, then performs rate-distortion cost calculation based on the prediction regions respectively corresponding to the 3 candidate interpolation filters, to obtain rate-distortion costs respectively corresponding to the 3 candidate interpolation filters, and then determines the candidate interpolation filter with the lowest rate-distortion cost as the target interpolation filter.

In some embodiments, after selecting the target interpolation filter from the plurality of candidate interpolation filters based on respective rate-distortion costs of the plurality of candidate interpolation filters, the encoder side writes the first indication information into the bitstream. The first indication information is configured for indicating index information of the target interpolation filter in the plurality of candidate interpolation filters. In this way, when determining the target interpolation filter, the decoder side determines the plurality of candidate interpolation filters through the foregoing operations and decodes the bitstream simultaneously, to obtain first indication information, and then selects the target interpolation filter from the plurality of candidate interpolation filters based on the first indication information.

In some embodiments, the first indication information includes a flag bit array or a plurality of flag bits, and the flag bit array or the plurality of flag bits are configured for indicating the coding information and the target interpolation filter.

In an example, the first indication information indicates the prediction mode, the coding component, and the target interpolation filter. In this case, the first indication information includes parsing a flag bit array Flag1[A][I] (A and I are both positive integers), where A represents a coding component, for example, A=0 represents a luminance component, and A=1 represents a chrominance component; I represents the prediction mode, for example, I=0 represents a mode 1, and I=1 represents a mode 2; and Flag1[A][I] represents index information of a target interpolation filter of a component A in the prediction mode I. For example, the first indication information and the meaning thereof are shown in Table 4.

In an example, the first indication information indicates the interpolation direction, the coding component, and the target interpolation filter. In this case, the first indication information includes parsing a flag bit array Flag2[A][B] (A and B are both positive integers), where A represents a coding component, for example, A=0 represents a luminance component, and A=1 represents a chrominance component; B represents the interpolation direction, for example, B=0 represents an x-direction, and B=1 represents a y-direction; and Flag2[A][B] represents index information of a target interpolation filter of a component A in the interpolation direction B. For example, the first indication information and the meaning thereof are shown in Table 5.

In an example, the first indication information indicates the interpolation target, the coding component, and the target interpolation filter. In this case, the first indication information includes parsing a flag bit array Flag3[A][D] (A and D are both positive integers), where A represents a coding component, for example, A=0 represents a luminance component, and A=1 represents a chrominance component; D represents the interpolation target, for example, D=0 represents that the interpolation target is to determine a predicted value, and D=1 represents that the interpolation target is to determine a gradient; and Flag3[A][D] represents index information of a target interpolation filter of a component A for the interpolation target D. For example, the first indication information and the meaning thereof are shown in Table 6.

In the implementation, the encoder side determines a plurality of candidate interpolation filters each having a different quantity of taps based on at least one of the prediction mode, the interpolation direction, the coding component, or the interpolation target corresponding to the to-be-encoded region, and then selects the target interpolation filter from the plurality of candidate interpolation filters each having a different quantity of taps.

In some embodiments, the encoder side may determine, as the target interpolation filter corresponding to the to-be-encoded region, a default interpolation filter corresponding to the at least one of the prediction mode, the interpolation direction, the coding component, or the interpolation target corresponding to the to-be-encoded region.

In an example 1, the encoder side determines the target interpolation filter based on the prediction mode, the coding component, and the interpolation target.

For example, both the encoder side and the decoder side are configured by default to use a specific N1-tap interpolation filter for the luminance and/or chrominance components targeting j1 interpolation targets in i prediction modes, and use a specific N2-tap interpolation filter for the luminance and/or chrominance components targeting j2 interpolation content in the remaining I-i prediction modes, where i, j1, j2, N1, and N2 are all integers, and N1 #N2.

For example, an n1-tap interpolation filter is determined as the target interpolation filter if the prediction mode of the to-be-encoded region is a BIO prediction mode, the coding component is a luminance component, and the interpolation target is to determine gradients of a forward prediction block and a backward prediction block of the to-be-encoded region in the x-direction and the y-direction;
an n2-tap interpolation filter is determined as the target interpolation filter if the prediction mode of the to-be-encoded region is the BIO prediction mode, the coding component is the luminance component, and the interpolation target is to determine the predicted values of the to-be-encoded region in the x-direction and the y-direction;
an n3-tap interpolation filter is determined as the target interpolation filter if the prediction mode of the to-be-encoded region is the BIO prediction mode, the coding component is the chrominance component, and the interpolation target is to determine the predicted values of the to-be-encoded region in the x-direction and the y-direction;
an n4-tap interpolation filter is determined as the target interpolation filter if the prediction mode of the to-be-encoded region is a non-BIO prediction mode, the coding component is the luminance component, and the interpolation target is to determine the predicted values of the to-be-encoded region in the x-direction and the y-direction; and
an n5-tap interpolation filter is determined as the target interpolation filter if the prediction mode of the to-be-encoded region is the non-BIO prediction mode, the coding component is the chrominance component, and the interpolation target is to determine the predicted values of the to-be-encoded region in the x-direction and the y-direction;
n1, n2, n3, n4, and n5 being all positive integers.

Specific values of the foregoing n1, n2, n3, n4, and n5 are not limited in this disclosure.

In a possible implementation, n1 is not equal to n2.

In an example, n1=8, n2=12, n3=6, n4=12, and n5=6.

It may be learned from the foregoing Table 7 that in one or more embodiments of this disclosure, in the BIO mode, a quantity of taps of an interpolation filter used for calculating the gradient is different from a quantity of taps of an interpolation filter used for calculating a pixel prediction value. For example, an 8-tap interpolation filter is used for calculating the gradient, and a 12-tap interpolation filter is used for calculating interpolation of the pixel prediction value.

In an example 2, the encoder side determines the target interpolation filter based on the prediction mode and the coding component.

For example, both the encoder side and the decoder side are configured by default to only use a specific N1-tap interpolation filter for the luminance and/or chrominance components in i prediction modes, and use a specific N2-tap interpolation filter for the luminance and/or chrominance components in the remaining I-i prediction modes (i, N1, and N2 are all integers, and N1≠N2).

For example, if the prediction mode of the to-be-encoded region is the BIO prediction mode and the coding component is the luminance component, an m1-tap interpolation filter is determined as the target interpolation filter, and in this case, the encoder side uses the m1-tap interpolation filter to perform gradient calculation and interpolation of the predicted value;
if the prediction mode of the to-be-encoded region is the BIO prediction mode and the coding component is the chrominance component, an m2-tap interpolation filter is determined as the target interpolation filter, and in this case, the encoder side uses the m2-tap interpolation filter to perform interpolation calculation of the predicted value in the x-direction and the y-direction;
if the prediction mode of the to-be-encoded region is the non-BIO prediction mode and the coding component is the luminance component, an m3-tap interpolation filter is determined as the target interpolation filter, and in this case, the encoder side uses the m3-tap interpolation filter to perform interpolation calculation of the predicted values in the x-direction and the y-direction; and
if the prediction mode of the to-be-encoded region is the non-BIO prediction mode and the coding component is the chrominance component, an m4-tap interpolation filter is determined as the target interpolation filter, and in this case, the encoder side uses the m4-tap interpolation filter to perform interpolation calculation of the predicted values in the x-direction and the y-direction;
m1, m2, m3, and m4 being all positive integers.

Specific values of the m1, m2, m3, and m4 are not limited in this disclosure.

In an example, m1=8, m2=6, m3=12, and m4=6.

In an example 3, the encoder side determines the target interpolation filter based on the interpolation direction and the coding component.

For example, the encoder side and the decoder side are configured by default to use an N1-tap interpolation filter for interpolation of content such as predicted values and gradients of luminance and/or chrominance components in the x-direction, and use an N2-tap interpolation filter for interpolation of content such as predicted values and gradients of luminance and/or chrominance components in the y-direction (N1 and N2 are both positive integers, and N1≠N2).

For example, if the interpolation direction of the to-be-encoded region is the x-direction and the coding component is the luminance component, a k1-tap interpolation filter is determined as the target interpolation filter, and in this case, the encoder side uses the k1-tap interpolation filter to perform gradient calculation and interpolation of the predicted value;
if the interpolation direction of the to-be-encoded region is the x-direction and the coding component is the chrominance component, a k2-tap interpolation filter is determined as the target interpolation filter, and in this case, the encoder side uses the k2-tap interpolation filter to perform gradient calculation and interpolation of the predicted value;
if the interpolation direction of the to-be-encoded region is the x-direction and the coding component is the luminance component, a k3-tap interpolation filter is determined as the target interpolation filter, and in this case, the encoder side uses the k3-tap interpolation filter to perform gradient calculation and interpolation of the predicted value; and
if the interpolation direction of the to-be-encoded region is the y-direction and the coding component is the chrominance component, a k4-tap interpolation filter is determined as the target interpolation filter, and in this case, the encoder side uses the k4-tap interpolation filter to perform gradient calculation and interpolation of the predicted value;
k1, k2, k3, and k4 being all positive integers.

Specific values of the k1, k2, k3, and k4 are not limited in this disclosure.

In an example, k1=12, k2=6, k3=8, and k4=4.

In an example 4, the encoder side determines the target interpolation filter based on the coding component and a size of the to-be-encoded region.

For example, both the encoder side and the decoder side are configured by default to use the N1-tap interpolation filter within a size range, and use the N2-tap interpolation filter within another size range (N1 and N2 are both positive integers, and N1 #N2).

For example, if the coding component of the to-be-encoded region is the luminance component, and a scale of the to-be-encoded region is w<=W1 or h<=H1, an a1-tap interpolation filter is determined as the target interpolation filter, and in this case, the encoder side uses the a1-tap interpolation filter to perform gradient calculation and interpolation of predicted value;
if the coding component of the to-be-encoded region is the luminance component, and the scale of the to-be-encoded region is w>W1 and h>H1, an a2-tap interpolation filter is determined as the target interpolation filter, and in this case, the encoder side uses the a2-tap interpolation filter to perform gradient calculation and interpolation of the predicted value;
if the coding component of the to-be-encoded region is the chrominance component, and the scale of the to-be-encoded region is w<=W2 or h<=H2, an a3-tap interpolation filter is determined as the target interpolation filter, and in this case, the encoder side uses the a3-tap interpolation filter to perform gradient calculation and interpolation of the predicted value; and
if the coding component of the to-be-encoded region is the chrominance component, and when a scale of the to-be-encoded region is w>W2 and h>H2, an a4-tap interpolation filter is determined as the target interpolation filter, and in this case, the encoder side uses the a4-tap interpolation filter to perform gradient calculation and interpolation of predicted value;
a1, a2, a3, and a4 being all positive integers.

Specific values of the a1, a2, a3, and a4 are not limited in this disclosure.

In an example, a1=8, a2=12, a3=4, and a4=6.

After determining the target interpolation filter based on the foregoing operations, the encoder side performs the following operation of S203.
S203: Perform interpolation on the reference region based on the target interpolation filter, to determine a predicted value of the to-be-encoded region.

The encoder side performs interpolation on the reference region of the to-be-encoded region by using the target interpolation filter after determining the target interpolation filter corresponding to the to-be-encoded region based on the foregoing operation, to determine the predicted value of the to-be-encoded region.

In an example, if the foregoing interpolation target is to perform interpolation on the pixel prediction value, the encoder side performs interpolation on the reference region by using the target interpolation filter, to obtain an interpolated prediction region, and then searches the interpolated prediction region to obtain a prediction block of the to-be-encoded region.

In an example, if the prediction mode corresponding to the to-be-encoded region in one or more embodiments of this disclosure is BIO, the encoder side first uses a bidirectional prediction mode to determine a forward reference block and a backward reference block of the to-be-encoded region. Next, the target interpolation filter is sampled to perform interpolation on the forward reference block and the backward reference block, to determine gradients of the forward reference block and the backward reference block, and then corrects motion vectors corresponding to the forward reference block and the backward reference block based on the gradients, to obtain the predicted value of the to-be-encoded region.

According to the video decoding method provided in one or more embodiments of this disclosure, the coding information of the to-be-encoded region and the reference region corresponding to the to-be-encoded region are obtained, the coding information including at least one of a prediction mode, an interpolation direction, an coding component, or an interpolation target. The target interpolation filter corresponding to the to-be-encoded region is determined based on the coding information, and then interpolation is performed on the reference region based on the target interpolation filter, to determine the predicted value of the to-be-encoded region. In other words, in one or more embodiments of this disclosure, the encoder side adaptively selects the target interpolation filter from interpolation filters each having a different quantity of taps based on the coding information of the to-be-encoded region and coding information of a to-be-decoded region, for example, the prediction mode, the interpolation direction, the coding component, and the interpolation target, thereby improving accuracy of selection of the target interpolation filter. In this way, when the interpolation is performed on the reference region of the to-be-encoded region based on the accurately selected target interpolation filter, to determine the predicted value of the to-be-encoded region, a prediction effect of the to-be-encoded region may be improved, thereby improving performance of video encoding.

The embodiments of the audio encoding and decoding method of this disclosure are described in detail above with reference to FIG. 5 to FIG. 8. Apparatus embodiments of this disclosure are described in detail below with reference to FIG. 9 to FIG. 10.

FIG. 9 is a schematic block diagram of a video decoding apparatus according to an embodiment of this disclosure. The apparatus 10 may be applied to a decoding device or a decoder.

As shown in FIG. 9, the video decoding apparatus 10 includes:
a decoding unit 11, configured to decode a bitstream, to obtain coding information of a to-be-decoded region, the coding information including at least one of a prediction mode, an interpolation direction, a coding component, or an interpolation target;
a determining unit 12, configured to determine a target interpolation filter corresponding to the to-be-decoded region based on the coding information; and
an interpolation unit 13, configured to determine a reference region of the to-be-decoded region, and perform interpolation on the reference region based on the target interpolation filter, to determine a predicted value of the to-be-decoded region.

In some embodiments, the interpolation unit 13 is specifically configured to: determine a plurality of candidate interpolation filters based on the coding information; decode a bitstream to obtain first indication information of the target interpolation filter, the first indication information being configured for indicating index information of the target interpolation filter in a plurality of candidate interpolation filters; and select the target interpolation filter from the plurality of candidate interpolation filters based on the first indication information.

In some embodiments, the interpolation unit 13 is specifically configured to: obtain preset candidate interpolation filters respectively corresponding to the at least one of the prediction mode, the interpolation direction, the coding component, or the interpolation target; and determine the plurality of candidate interpolation filters based on the preset candidate interpolation filters.

In some embodiments, the interpolation unit 13 is specifically configured to remove a duplicate interpolation filter from the preset candidate interpolation filters, to obtain the plurality of candidate interpolation filters.

In some embodiments, the interpolation unit 13 is specifically configured to: obtain the selection strategies respectively corresponding to the at least one of the prediction mode, the interpolation direction, the coding component, or the interpolation target, and select the plurality of candidate interpolation filters from preset M interpolation filters based on the selection strategies, M being a positive integer greater than 1; or obtain N candidate combinations formed by the M interpolation filters, decode a bitstream to obtain second indication information, select a target candidate combination from the N candidate combinations based on the second indication information, and then determine interpolation filters included in the target candidate combination as the plurality of candidate interpolation filters. Each of the candidate combinations includes two or more of the M interpolation filters, and the second indication information is configured for indicating the target candidate combination, N being a positive integer greater than 1.

In some embodiments, the interpolation filters included in a different candidate combination in the N candidate combinations are randomly distributed, or a quantity of interpolation filters included in each of the N candidate combinations progressively increases, and quantities of taps of the interpolation filters included in each candidate combination successively increase or decrease.

In some embodiments, if the first indication information includes a flag bit array or a plurality of flag bits, and the flag bit array or the plurality of flag bits are configured for indicating the coding information and the target interpolation filter, the decoding unit 11 is further configured to decode the bitstream to obtain the first indication information; and obtain coding information of the to-be-decoded region based on the first indication information.

In some embodiments, the interpolation unit 13 is specifically configured to: determine the target interpolation filter based on the prediction mode, the coding component, and the interpolation target; or determine the target interpolation filter based on the prediction mode and the coding component; or determine the target interpolation filter based on the interpolation direction and the coding component; or determine the target interpolation filter based on the coding component and a size of the to-be-decoded region.

In some embodiments, the interpolation unit 13 is specifically configured to: determine an n1-tap interpolation filter as the target interpolation filter if the prediction mode is a BIO prediction mode, the coding component is a luminance component, and the interpolation target is to determine gradients of a forward prediction block and a backward prediction block of the to-be-decoded region in an x-direction and a y-direction; determine an n2-tap interpolation filter as the target interpolation filter if the prediction mode is the BIO prediction mode, the coding component is the luminance component, and the interpolation target is to determine predicted values of the to-be-decoded region in the x-direction and the y-direction; determine an n3-tap interpolation filter as the target interpolation filter if the prediction mode is the BIO prediction mode, the coding component is a chrominance component, and the interpolation target is to determine the predicted values of the to-be-decoded region in the x-direction and the y-direction; determine an n4-tap interpolation filter as the target interpolation filter if the prediction mode is a non-BIO prediction mode, the coding component is the luminance component, and the interpolation target is to determine predicted the values of the to-be-decoded region in the x-direction and the y-direction; and determine an n5-tap interpolation filter as the target interpolation filter if the prediction mode is the non-BIO prediction mode, the coding component is the chrominance component, and the interpolation target is to determine the predicted values of the to-be-decoded region in the x-direction and the y-direction, where n1, n2, n3, n4, and n5 are all positive integers.

In some embodiments, n1 is not equal to n2.

In some embodiments, n1 is equal to 8, n2 is equal to 12, n3 is equal to 6, n4 is equal to 12, and n5 is equal to 6.

The apparatus embodiments and the method embodiments may correspond to each other, and for the similar description, reference may be made to the method embodiments. To avoid repetition, details are not described herein again. In at least one aspect, the apparatus shown in FIG. 9 may perform the embodiments of the foregoing video decoding method. In addition, the foregoing and other operations and/or functions of the modules in the apparatus are respectively configured for implementing the foregoing method embodiments. For brevity, details are not described herein again.

FIG. 10 is a schematic block diagram of a video encoding apparatus according to an embodiment of this disclosure. The apparatus 20 may be applied to an encoding device or an encoder.

As shown in FIG. 10, the video encoding apparatus 20 includes:
an obtaining unit 21, configured to obtain coding information of a to-be-encoded region, and a reference region corresponding to the to-be-encoded region, the coding information including at least one of a prediction mode, an interpolation direction, an coding component, or an interpolation target;
a determining unit 22, configured to determine a target interpolation filter corresponding to the to-be-encoded region based on the coding information; and
an interpolation unit 23, configured to perform interpolation filtering on the reference region based on the target interpolation filter, to determine a predicted value of the to-be-encoded region.

In some embodiments, the interpolation unit 23 is specifically configured to determine a plurality of candidate interpolation filters based on the coding information; and select the target interpolation filter from the plurality of candidate interpolation filters.

In some embodiments, the interpolation unit 23 is specifically configured to: obtain preset candidate interpolation filters respectively corresponding to the at least one of the prediction mode, the interpolation direction, the coding component, or the interpolation target; and determine the plurality of candidate interpolation filters based on the preset candidate interpolation filters.

In some embodiments, the interpolation unit 23 is specifically configured to remove a duplicate interpolation filter from the preset candidate interpolation filters, to obtain the plurality of candidate interpolation filters.

In some embodiments, the interpolation unit 23 is specifically configured to: obtain selection strategies respectively corresponding to the at least one of the prediction mode, the interpolation direction, the coding component, or the interpolation target; and select the plurality of candidate interpolation filters from preset M interpolation filters based on the selection strategies, M being a positive integer greater than 1.

In some embodiments, the interpolation unit 23 is specifically configured to: obtain N candidate combinations formed by the M interpolation filters, each of the candidate combinations including two or more of the M interpolation filters and N being a positive integer greater than 1; and select a target candidate combination from the N candidate combinations based on the selection strategies, and determine interpolation filters included in the target candidate combination as the plurality of candidate interpolation filters.

In some embodiments, the interpolation filters included in a different candidate combination in the N candidate combinations are randomly distributed, or a quantity of interpolation filters included in each of the N candidate combinations progressively increases, and quantities of taps of the interpolation filters included in each candidate combination successively increase or decrease.

In some embodiments, the interpolation unit 23 is specifically configured to: perform interpolation on each of the plurality of candidate interpolation filters by using the candidate interpolation filter based on the reference region, to obtain an interpolated prediction region; determine a rate-distortion cost corresponding to the candidate interpolation filter based on the interpolated prediction region; and select the target interpolation filter from the plurality of candidate interpolation filters based on the rate-distortion cost corresponding to each of the plurality of candidate interpolation filters.

In some embodiments, the interpolation unit 23 is further configured to write the first indication information into the bitstream. The first indication information is configured for indicating index information of the target interpolation filter in the plurality of candidate interpolation filters.

In some embodiments, the first indication information includes a flag bit array or a plurality of flag bits, and the flag bit array or the plurality of flag bits are configured for indicating the coding information and the target interpolation filter.

In some embodiments, the interpolation unit 23 is further configured to write second indication information into a bitstream. The second indication information is configured for indicating the target candidate combination.

In some embodiments, the interpolation unit 23 is specifically configured to: determine the target interpolation filter based on the prediction mode, the coding component, and the interpolation target; or determine the target interpolation filter based on the prediction mode and the coding component; or determine the target interpolation filter based on the interpolation direction and the coding component; or determine the target interpolation filter based on the coding component and a size of the to-be-encoded region.

In some embodiments, the interpolation unit 23 is further configured to: determine an n1-tap interpolation filter as the target interpolation filter if the prediction mode is a BIO prediction mode, the coding component is a luminance component, and the interpolation target is to determine gradients of a forward prediction block and a backward prediction block of the to-be-encoded region in an x-direction and a y-direction; determine an n2-tap interpolation filter as the target interpolation filter if the prediction mode is the BIO prediction mode, the coding component is the luminance component, and the interpolation target is to determine predicted values of the to-be-encoded region in the x-direction and the y-direction; determine an n3-tap interpolation filter as the target interpolation filter if the prediction mode is the BIO prediction mode, the coding component is a chrominance component, and the interpolation target is to determine the predicted values of the to-be-encoded region in the x-direction and the y-direction; determine an n4-tap interpolation filter as the target interpolation filter if the prediction mode is a non-BIO prediction mode, the coding component is the luminance component, and the interpolation target is to determine predicted the values of the to-be-encoded region in the x-direction and the y-direction; and determine an n5-tap interpolation filter as the target interpolation filter if the prediction mode is the non-BIO prediction mode, the coding component is the chrominance component, and the interpolation target is to determine the predicted values of the to-be-encoded region in the x-direction and the y-direction, where n1, n2, n3, n4, and n5 are all positive integers.

In some embodiments, n1 is not equal to n2.

In some embodiments, n1 is equal to 8, n2 is equal to 12, n3 is equal to 6, n4 is equal to 12, and n5 is equal to 6.

The apparatus embodiments and the method embodiments may correspond to each other, and for the similar description, reference may be made to the method embodiments. To avoid repetition, details are not described herein again. In at least one aspect, the apparatus shown in FIG. 10 may perform the embodiments of the foregoing video encoding method. In addition, the foregoing and other operations and/or functions of the modules in the apparatus are respectively configured for implementing the foregoing method embodiments. For brevity, details are not described herein again.

The apparatus in one or more embodiments of this disclosure is described above from the perspective of functional modules with reference to the accompanying drawings. The functional modules may be implemented in the form of hardware, or may be implemented through instructions in the form of software, and may further be implemented through a combination of hardware and software modules. In at least one aspect, the operations of the method embodiments in one or more embodiments of this disclosure may be completed through an integrated logic circuit of hardware in a processor and/or the instructions in the form of software. The operations of the method disclosed in combination with the embodiments of this disclosure may be directly performed by a hardware decoding processor, or may be performed through a combination of hardware and software modules in the decoding processor. In some embodiments, a software module may be located in a mature storage medium in the art, such as a random access memory (RAM), a flash memory, a read-only memory (ROM), a programmable ROM, an electrically erasable programmable memory, or a register. The storage medium is located in the memory, and the processor reads information in the memory, and completes the operations in the foregoing method embodiments in combination with hardware thereof.

FIG. 11 is a schematic block diagram of an electronic device according to an embodiment of this disclosure. The electronic device in FIG. 11 may be the foregoing encoding device (or an encoder) or the decoding device (or a decoder).

As shown in FIG. 11, the electronic device 30 may include a memory 31 and processing circuitry (e.g., a processor 32). The memory 31 is configured to store a computer program 33 and transmit the computer program 33 to the processor 32. In other words, the processor 32 may invoke the computer program 33 from the memory 31 and run the computer program to implement the method in one or more embodiments of this disclosure.

For example, the processor 32 may be configured to perform the operations in the foregoing method based on the instructions in the computer program 33.

In some embodiments of this disclosure, the processor 32 may include, but is not limited to: a general-purpose processor, a digital signal processor (DSP), an application specific integrated circuit (ASIC), a field programmable gate array (FPGA), or another programmable logic device, a discrete gate or a transistor logic device, a discrete hardware component, or the like.

In some embodiments, the memory 31 includes a non-transitory computer-readable storage medium. In some embodiments of this disclosure, the memory 31 includes, but is not limited to: a volatile memory and/or a non-volatile memory. The non-volatile memory may be a ROM, a programmable ROM (PROM), an erasable PROM (EPROM), an electrically EPROM (EEPROM), or a flash memory. The volatile memory may be a RAM that is used as an external cache. Through examples but not limitation, many forms of RAMs may be used, for example, a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM).

In some embodiments of this disclosure, the computer program 33 may be divided into one or more modules, the one or more modules being stored in the memory 31 and executed by the processor 32 to perform a page recording method provided in this disclosure. The one or more modules may be a series of computer program instruction segments that can implement specific functions. The instruction segments are configured for describing an execution process of the computer program 33 in the electronic device.

As shown in FIG. 11, the electronic device 30 may further include: a transceiver 34. The transceiver 34 may be connected to the processor 32 or the memory 31.

The processor 32 may control the transceiver 34 to communicate with another device, and in at least one aspect, may transmit information or data to another device, or receive information or data transmitted by another device. The transceiver 34 may include a transmitter and a receiver. The transceiver 34 may further include an antenna. One or more antennas may be arranged.

Various components in the electronic device 30 are connected through a bus system. In addition to a data bus, the bus system further includes a power bus, a control bus, and a status signal bus.

According to an aspect of this disclosure, a computer storage medium is provided. The computer storage medium has a computer program stored therein. The computer program, when executed by a computer, causes the computer to perform the method in the foregoing method embodiments. Alternatively, this embodiment of this disclosure further provides a computer program product including instructions, the instructions, when executed by a computer, causing the computer to perform the method in the foregoing method embodiment.

According to another aspect of this disclosure, a computer program product or a computer program is provided, the computer program product or the computer program including computer instructions, the computer instructions being stored in a non-transitory computer-readable storage medium. A processor of a computer device reads the computer instructions from the non-transitory computer-readable storage medium. The processor executes the computer instructions, to cause the computer device to perform the method in the foregoing method embodiments.

In other words, when the embodiment is implemented through software, all or some of the embodiments may be implemented in a form of a computer program product. The computer program product includes one or more computer instructions. When the computer program instructions are loaded and executed on the computer, the processes or functions according to the embodiments of this disclosure are all or partially generated. The computer may be a general-purpose computer, a dedicated computer, a computer network, or another programmable apparatus. The computer instructions may be stored in the non-transitory computer-readable storage medium, or may be transmitted from the non-transitory computer-readable storage medium to another non-transitory computer-readable storage medium. For example, the computer instructions may be transmitted from a website, a computer, a server, or a data center to another website, computer, server, or data center in a wired (for example, a coaxial cable, an optical fiber, or a digital subscriber line (DSL)) or wireless (for example, infrared, radio, or microwave) manner. The non-transitory computer-readable storage medium may be any available medium accessible by a computer, or may be a data storage device such as a server or a data center integrated with one or more available media. The available medium may be a magnetic medium (for example, a floppy disk, a hard disk, or a magnetic tape), an optical medium (for example, a digital video disc (DVD)), a semiconductor medium (for example, a solid state disk (SSD)), or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely non-limiting embodiments of this disclosure, and are not intended to limit the scope of this disclosure. Any variation or replacement without departing from this disclosure shall fall within the scope of this disclosure. s

What is claimed is:

1. A video decoding method, the method comprising:
obtaining, from a bitstream, coding information of a to-be-decoded region, the coding information indicating at least one of a prediction mode, an interpolation direction, a coding component, or an interpolation target;
determining, by processing circuitry, a target interpolation filter corresponding to the to-be-decoded region from a plurality of candidate interpolation filters based on the coding information, the plurality of candidate interpolation filters having different filter taps; and
determining, by the processing circuitry, a predicted value of the to-be-decoded region through application of the target interpolation filter on a reference region.

2. The method according to claim 1, wherein the determining the target interpolation filter comprises:
determining the plurality of candidate interpolation filters based on the coding information;
obtaining, from the bitstream, first indication information of the target interpolation filter, the first indication information indicating index information of the target interpolation filter in the plurality of candidate interpolation filters; and
selecting the target interpolation filter from the plurality of candidate interpolation filters based on the first indication information.

3. The method according to claim 2, wherein the determining the plurality of candidate interpolation filters comprises:
obtaining preset candidate interpolation filters that include a respective subset of candidate interpolation filters corresponding to each one of the at least one of the prediction mode, the interpolation direction, the coding component, or the interpolation target; and
determining the plurality of candidate interpolation filters based on the preset candidate interpolation filters.

4. The method according to claim 3, wherein the determining the plurality of candidate interpolation filters based on the preset candidate interpolation filters comprises:
removing a duplicate interpolation filter from the preset candidate interpolation filters, to obtain the plurality of candidate interpolation filters.

5. The method according to claim 2, wherein the determining the plurality of candidate interpolation filters comprises:
obtaining a set of selection strategies that includes a respective selection strategy corresponding to each one of the at least one of the prediction mode, the interpolation direction, the coding component, or the interpolation target, and selecting the plurality of candidate interpolation filters from M preset interpolation filters based on the set of selection strategies, M being a positive integer greater than 1; or
obtaining N candidate combinations of two or more of the M preset interpolation filters, obtaining second indication information from the bitstream, selecting a target candidate combination from the N candidate combinations based on the second indication information, and determining interpolation filters in the target candidate combination as the plurality of candidate interpolation filters, N being a positive integer greater than 1.

6. The method according to claim 5, wherein
the interpolation filters in each candidate combination of the N candidate combinations are randomly selected from the M preset interpolation filters,
a quantity of interpolation filters in each candidate combination of the N candidate combinations increases while a maximum quantity of taps of the interpolation filters in each candidate combination of the N candidate combinations increases, or
the quantity of interpolation filters in each candidate combination of the N candidate combinations increases while a minimum quantity of taps of the interpolation filters in each candidate of the N combination candidate combinations decreases.

7. The method according to claim 2, further comprising:
decoding the bitstream to obtain the first indication information that includes a flag bit array or a plurality of flag bits indicating the coding information and the target interpolation filter,
wherein the coding information of the to-be-decoded region is obtained based on the first indication information.

8. The method according to claim 1, wherein the determining the target interpolation filter comprises:
determining the target interpolation filter based on the prediction mode, the coding component, and the interpolation target;
determining the target interpolation filter based on the prediction mode and the coding component;
determining the target interpolation filter based on the interpolation direction and the coding component; or
determining the target interpolation filter based on the coding component and a size of the to-be-decoded region.

9. The method according to claim 1, wherein the determining the target interpolation filter comprises:
determining an n1-tap interpolation filter as the target interpolation filter when the prediction mode is a bi-directional optical flow (BIO) prediction mode, the coding component is a luminance component, and the interpolation target is to determine gradients of a forward prediction block and a backward prediction block of the to-be-decoded region in an x-direction and a y-direction;
determining an n2-tap interpolation filter as the target interpolation filter when the prediction mode is the BIO prediction mode, the coding component is the luminance component, and the interpolation target is to determine the predicted values of the to-be-decoded region in the x-direction and the y-direction;
determining an n3-tap interpolation filter as the target interpolation filter when the prediction mode is the BIO prediction mode, the coding component is a chrominance component, and the interpolation target is to determine the predicted values of the to-be-decoded region in the x-direction and the y-direction;
determining an n4-tap interpolation filter as the target interpolation filter when the prediction mode is a non-BIO prediction mode, the coding component is the luminance component, and the interpolation target is to determine the predicted values of the to-be-decoded region in the x-direction and the y-direction; and
determining an n5-tap interpolation filter as the target interpolation filter when the prediction mode is the non-BIO prediction mode, the coding component is the chrominance component, and the interpolation target is to determine the predicted values of the to-be-decoded region in the x-direction and the y-direction,
n1, n2, n3, n4, and n5 being positive integers.

10. The method according to claim 9, wherein n1 is not equal to n2.

11. The method according to claim 9, wherein n1 is equal to 8, n2 is equal to 12, n3 is equal to 6, n4 is equal to 12, and n5 is equal to 6.

12. A video encoding method, the method comprising:
obtaining coding information of a to-be-encoded region, and a reference region corresponding to the to-be-encoded region, the coding information indicating at least one of a prediction mode, an interpolation direction, a coding component, or an interpolation target;
determining, by processing circuitry, a target interpolation filter corresponding to the to-be-encoded region from a plurality of candidate interpolation filters based on the coding information, the plurality of candidate interpolation filters having different filter taps; and
performing, by the processing circuitry, interpolation filtering on the reference region based on the target interpolation filter, to determine a predicted value of the to-be-encoded region.

13. The method according to claim 12, wherein the determining the target interpolation filter comprises:
determining the plurality of candidate interpolation filters based on the coding information; and
selecting the target interpolation filter from the plurality of candidate interpolation filters.

14. The method according to claim 13, wherein the determining the plurality of candidate interpolation filters comprises:
obtaining preset candidate interpolation filters that include a respective subset of candidate interpolation filters corresponding to each one of the at least one of the prediction mode, the interpolation direction, the coding component, or the interpolation target; and
determining the plurality of candidate interpolation filters based on the preset candidate interpolation filters.

15. The method according to claim 13, wherein the determining the plurality of candidate interpolation filters comprises:
obtaining a set of selection strategies that includes a respective selection strategy corresponding to each one of the at least one of the prediction mode, the interpolation direction, the coding component, or the interpolation target; and
selecting the plurality of candidate interpolation filters from M preset interpolation filters based on the set of selection strategies, M being a positive integer greater than 1.

16. The method according to claim 12, wherein the determining the target interpolation filter comprises:
determining the target interpolation filter based on the prediction mode, the coding component, and the interpolation target;
determining the target interpolation filter based on the prediction mode and the coding component;
determining the target interpolation filter based on the interpolation direction and the coding component; or
determining the target interpolation filter based on the coding component and a size of the to-be-encoded region.

17. A video decoding apparatus, comprising:
processing circuitry configured to:
obtain, from a bitstream, coding information of a to-be-decoded region, the coding information indicating at least one of a prediction mode, an interpolation direction, a coding component, or an interpolation target;
determine a target interpolation filter corresponding to the to-be-decoded region from a plurality of candidate interpolation filters based on the coding information, the plurality of candidate interpolation filters having different filter taps; and
determine a predicted value of the to-be-decoded region through application of the target interpolation filter on a reference region.

18. The apparatus according to claim 17, wherein the processing circuitry is configured to:
determine the plurality of candidate interpolation filters based on the coding information; and
select the target interpolation filter from the plurality of candidate interpolation filters.

19. The apparatus according to claim 18, wherein the processing circuitry is configured to:
obtain preset candidate interpolation filters that include a respective subset of candidate interpolation filters corresponding to each one of the at least one of the prediction mode, the interpolation direction, the coding component, or the interpolation target; and
determine the plurality of candidate interpolation filters based on the preset candidate interpolation filters.

20. The apparatus according to claim 18, wherein the processing circuitry is configured to:
obtain a set of selection strategies that includes a respective selection strategy corresponding to each one of the at least one of the prediction mode, the interpolation direction, the coding component, or the interpolation target; and
select the plurality of candidate interpolation filters from M preset interpolation filters based on the set of selection strategies, M being a positive integer greater than 1.
